(19) United States
(12) Patent Application Publication
(10) Pub. No.: US 2025/0098021 A1
(43) Pub. Date: Mar. 20, 2025

(54) METHOD FOR CONNECTION ESTABLISHMENT AND TERMINAL

(71) Applicant: GUANGDONG OPPO MOBILE TELECOMMUNICATIONS CORP., LTD., Dongguan (CN)

(72) Inventors: Boyuan ZHANG, Dongguan (CN); Qianxi LU, Dongguan (CN); Bingxue LENG, Dongguan (CN)

(21) Appl. No.: 18/969,250

(22) Filed: Dec. 4, 2024

Related U.S. Application Data
(63) Continuation of application No. PCT/CN2022/107480, filed on Jul. 22, 2022.

(51) Int. Cl. H04W 76/27; H04W 72/25

(52) U.S. Cl. CPC H04W 76/27; H04W 72/25

(57) ABSTRACT

The present disclosure relates to methods for connection establishment and terminals. The method includes the following. When establishment of a first sidelink (SL) radio resource-control (RRC) between a first terminal and a second terminal is completed and establishment of a second SL RRC connection between the second terminal and a third terminal is completed, the first terminal establishes a third SL RRC connection with the third terminal via the second terminal.

### CROSS REFERENCE TO RELATED APPLICATION(S)

This application is a continuation of International Application No. PCT/CN2022/107480, filed Jul. 22, 2022, the entire disclosure of which is incorporated herein by reference.

### TECHNICAL FIELD

This disclosure relates to the field of communication, and in particular to methods for connection establishment and terminals.

### BACKGROUND

Device-to-device (D2D) communication is a sidelink (SL) transmission technology. Unlike the manner adopted in a conventional cellular system in which communication data is received or sent by a base station, terminal-to-terminal direct communication is adopted in a D2D communication system, so that higher spectrum efficiency and lower transmission latency are achieved. However, how to expand the communication range of SL terminals becomes a problem to be solved.

### SUMMARY

Embodiments of the present disclosure provide a method for connection establishment. The method includes the following. When establishment of a first sidelink (SL) radio resource-control (RRC) between a first terminal and a second terminal is completed and establishment of a second SL RRC connection between the second terminal and a third terminal is completed, the first terminal establishes a third SL RRC connection with the third terminal via the second terminal.

Embodiments of the present disclosure provide a method for connection establishment. The method includes the following. A second terminal establishes a first SL RRC connection with a first terminal. The second terminal establishes a second SL RRC connection with a third terminal.

Embodiments of the present disclosure provide a first terminal. The first terminal includes a processor and a memory. The memory is configured to store a computer program. The processor is configured to invoke and execute the computer program stored in the memory, to cause a terminal device to perform the method for connection establishment.

### BRIEF DESCRIPTION OF THE DRAWINGS

FIG. 1 is a schematic diagram of an application scenario according to embodiments of the present disclosure.

FIG. 2a and FIG. 2b are schematic diagrams of device-to-device (D2D) scenarios according to the present disclosure.

FIG. 3 is a schematic flowchart of a method for connection establishment according to an embodiment of the present disclosure.

FIG. 4 is a schematic flowchart of a method for connection establishment according to another embodiment of the present disclosure.

FIG. 5 is a flowchart of an exemplary scenario of a method for connection establishment according to an embodiment of the present disclosure.

FIG. 6 is a schematic block diagram of a first terminal according to an embodiment of the present disclosure.

FIG. 7 is a schematic block diagram of a first terminal according to another embodiment of the present disclosure.

FIG. 8 is a schematic block diagram of a second terminal according to an embodiment of the present disclosure.

FIG. 9 is a schematic block diagram of a second terminal according to another embodiment of the present disclosure.

FIG. 10 is a schematic block diagram of a communication device according to embodiments of the present disclosure.

FIG. 11 is a schematic block diagram of a chip according to embodiments of the present disclosure.

FIG. 12 is a schematic block diagram of a communication system according to embodiments of the present disclosure.

FIG. 13 is another schematic block diagram of a communication system according to embodiments of the present disclosure.

### DETAILED DESCRIPTION

The following will describe technical solutions of embodiments of the present disclosure with reference to accompanying drawings in embodiments of the present disclosure.

The technical solutions of embodiments of the present disclosure are applicable to various communication systems, for example, a global system of mobile communication (GSM), a code division multiple access (CDMA) system, a wideband code division multiple access (WCDMA) system, a general packet radio service (GPRS), a long term evolution (LTE) system, an advanced LTE (LTE-A) system, a new radio (NR) system, an evolved system of an NR system, an LTE-based access to unlicensed spectrum (LTE-U) system, an NR-based access to unlicensed spectrum (NR-U) system, a non-terrestrial network (NTN) system, a universal mobile telecommunication system (UMTS), a wireless local area network (WLAN), a wireless fidelity (WiFi), a 5th-generation (5G) system, other communication systems, etc.

Generally speaking, a conventional communication system generally supports a limited quantity of connections and therefore is easy to implement. However, with the development of communication technology, a mobile communication system will not only support conventional communication but also support, for example, device-to-device (D2D) communication, machine-to-machine (M2M) communication, machine-type communication (MTC), vehicle-to-vehicle (V2V) communication, vehicle-to-everything (V2X), etc. The above communication systems are also applicable to embodiments of the present disclosure.

In an embodiment, the communication system in embodiments of the present disclosure is applicable to a carrier aggregation (CA) scenario, or is applicable to a dual connectivity (DC) scenario, or is applicable to a standalone (SA) network deployment scenario. In an embodiment, the communication system in embodiments of the present disclosure is applicable to an unlicensed spectrum, and an unlicensed spectrum can be regarded as a shared spectrum. Alternatively, the communication system in embodiments of the present disclosure is applicable to a licensed spectrum, and a licensed spectrum can be regarded as a non-shared spectrum.

Various embodiments of the present disclosure are described in connection with a network device and a terminal device. The terminal device can also be referred to as a user equipment (UE), an access terminal, a subscriber unit, a subscriber station, a mobile station, a remote station, a remote terminal, a mobile device, a user terminal, a terminal, a wireless communication device, a user agent, or a user device, etc. The terminal device can be a station (ST) in a WLAN, a cellular radio telephone, a cordless telephone, a session initiation protocol (SIP) telephone, a wireless local loop (WLL) station, a personal digital assistant (PDA), a handheld device or a computing device with wireless communication functions, other processing devices coupled with a wireless modem, an in-vehicle device, a wearable device, and a terminal device in a next-generation communication system, for example, a terminal device in an NR network, or a terminal device in a future evolved public land mobile network (PLMN), etc.

In embodiments of the present disclosure, the terminal device can be deployed on land, which includes indoor or outdoor, handheld, wearable, or in-vehicle. The terminal device can also be deployed on water (such as ships, etc.). The terminal device can also be deployed in the air (such as airplanes, balloons, satellites, etc.). In embodiments of the present disclosure, the terminal device can be a mobile phone, a pad, a computer with wireless transceiver functions, a virtual reality (VR) terminal device, an augmented reality (AR) terminal device, a wireless terminal device in industrial control, a wireless terminal device in self-driving, a wireless terminal device in remote medicine, a wireless terminal device in smart grid, a wireless terminal device in transportation safety, a wireless terminal device in smart city, a wireless terminal device in smart home, etc. By way of explanation rather than limitation, in embodiments of the present disclosure, the terminal device can also be a wearable device. The wearable device can also be referred to as a wearable smart device, which is a generic term of wearable devices obtained through intelligentization design and development on daily wearing products with wearable technology, for example, glasses, gloves, watches, clothes, accessories, and shoes. The wearable device is a portable device that can be directly worn or integrated into clothes or accessories of a user. In addition to being a hardware device, the wearable device can also realize various functions through software support, data interaction, and cloud interaction. A wearable smart device in a broad sense includes, for example, a smartwatch or smart glasses with complete functions and large sizes and capable of realizing independently all or part of the functions of a smartphone, and for example, various types of smart bands and smart jewelries for physical monitoring, of which each is dedicated to application functions of a certain type and required to be used together with other devices such as a smartphone.

In embodiments of the present disclosure, the network device can be a device configured to communicate with a mobile device, and the network device can be an access point (AP) in a WLAN, a base transceiver station (BTS) in GSM or CDMA, or can be a Node B (NB) in WCDMA, or can be an evolutional Node B (eNB or eNodeB) in LTE, or a relay station or AP, or an in-vehicle device, a wearable device, a network device (gNB) in an NR network, a network device in a future evolved PLMN, or a network device in an NTN, etc. By way of explanation rather than limitation, in embodiments of the present disclosure, the network device can be mobile. For example, the network device can be a mobile device. Optionally, the network device can be a satellite or a balloon base station. For example, the satellite can be a low earth orbit (LEO) satellite, a medium earth orbit (MEO) satellite, a geostationary earth orbit (GEO) satellite, a high elliptical orbit (HEO) satellite, etc. Optionally, the network device can also be a base station deployed on land or water. In embodiments of the present disclosure, the network device serves a cell, and the terminal device communicates with the network device on a transmission resource (for example, a frequency-domain resource or a spectrum resource) for the cell. The cell can be a cell corresponding to the network device (for example, a base station). The cell can belong to a macro base station, or can belong to a base station corresponding to a small cell. The small cell can include: a metro cell, a micro cell, a pico cell, a femto cell, and the like. These small cells are characterized by small coverage and low transmission power and are adapted to provide data transmission service at a high-rate.

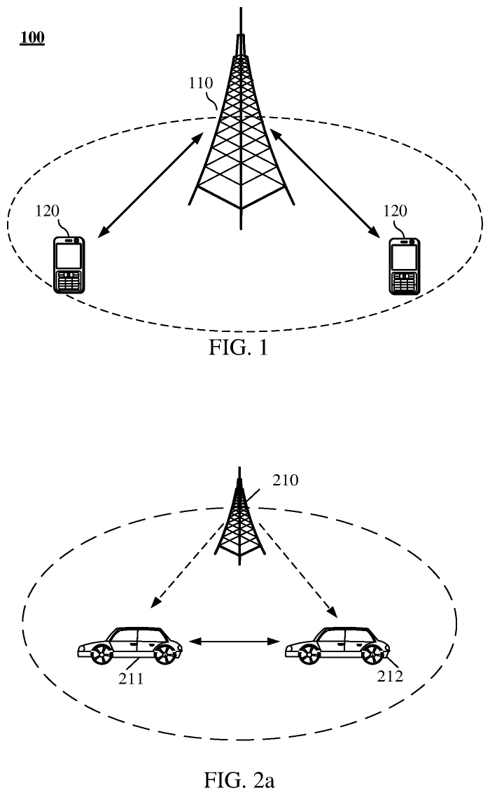

FIG. 1 exemplarily illustrates a communication system 100. The communication system 100 includes one network device 110 and two terminal devices 120. In an embodiment, the communication system 100 can also include multiple network devices 110, and there can be other quantities of terminal devices 120 in the coverage of each of the network devices 110, which is not limited in embodiments of the present disclosure. In an embodiment, the communication system 100 can also include other network entities such as a mobility management entity (MME), an access and mobility management function (AMF), etc., which is not limited in embodiments of the present disclosure. The network device can also include an access network (AN) device and a core network (CN) device. That is, the wireless communication system also includes multiple core networks for communicating with the AN device. The AN device can be an evolutional Node B (eNB or eNodeB), a macro base station, a micro base station (also referred to as “small base station”), a pico base station, an AP, a transmission point (TP), a new generation Node B (gNodeB), etc., in the LTE system, a next-generation NR system, or an authorized auxiliary access long-term evolution (LAA-LTE) system.

It can be understood that, in embodiments of the present disclosure, a device with communication functions in a network/system can be referred to as a “communication device”. Taking the communication system illustrated in FIG. 1 as an example, the communication device can include the network device and the terminal device(s) that have communication functions. The network device and the terminal device(s) can be the devices in embodiments of the present disclosure, which is not repeated herein. The communication device can further include other devices such as a network controller, an MME, or other network entities in the communication system, which is not limited in embodiments of the present disclosure.

It can be understood that, the terms “system” and “network” herein are usually used interchangeably throughout the present disclosure. The term “and/or” herein only describes an association relationship between associated objects, which means that there can be three relationships. For example, A and/or B can mean A alone, both A and B exist, and B alone. In addition, the character “/”′ herein generally indicates that the associated objects are in an “or” relationship. It can be understood that, “indication” referred to in embodiments of the present disclosure can be a direct indication, can be an indirect indication, or can mean that there is an association relationship. For example, A indicates B can mean that A directly indicates B, for instance, B can be obtained according to A; can mean that A indirectly indicates B, for instance, A indicates C, and B can be obtained according to C; or can mean that there is an association relationship between A and B. In the elaboration of embodiments of the present disclosure, the term “correspondence” can mean that there is a direct or indirect correspondence between the two, can mean that there is an association between the two, can mean a relationship of indicating and indicated or configuring and configured, etc.

For a better understanding of technical solutions of embodiments of the present disclosure, the technical solutions of the present disclosure will be described in detail below in connection with embodiments. The following related art as an optional solution can be arbitrarily combined with the technical solutions of embodiments of the present disclosure, which shall all belong to the protection scope of embodiments of the present disclosure.

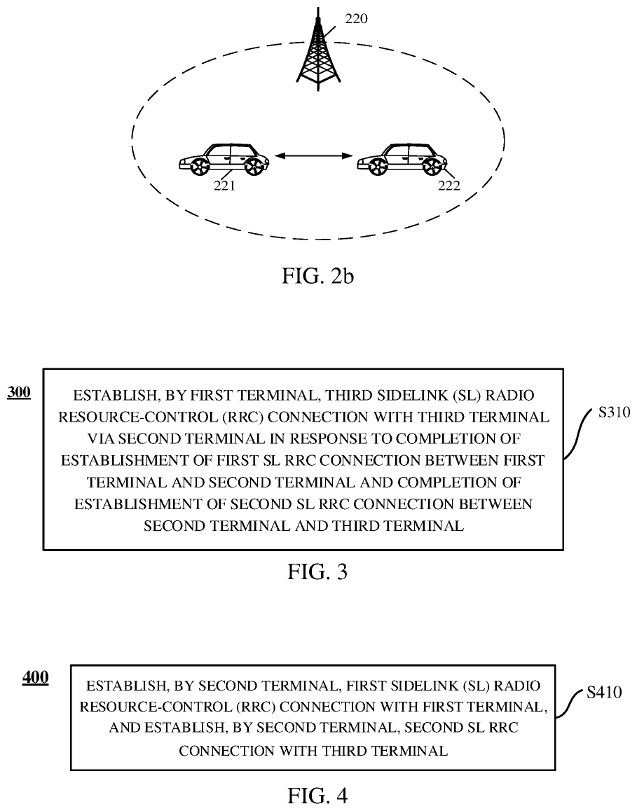

In LTE V2X, D2D communication is a D2D-based sidelink (SL) transmission technology. Unlike a manner adopted in a conventional cellular system in which communication data is received or sent by a base station, terminal-to-terminal direct communication is adopted in a V2X system, so that higher spectrum efficiency and lower transmission latency are achieved. In the 3rd generation partnership project (3GPP), two transmission modes are defined, that is, mode A and mode B. In mode A, as illustrated in FIG. 2a, transmission resources for terminal devices are allocated by a network device 210, and the terminal devices (a terminal device 211 and a terminal device 212 in FIG. 2a) send data on the SL according to the resources allocated by the network device 210. The network device 210 can allocate resources for single transmission to the terminal device, or can allocate resources for semi-persistent transmission to the terminal device. As illustrated in FIG. 2a, a bidirectional solid arrow indicates an SL between the terminal device 211 and the terminal device 212, and a dotted arrow indicates a downlink (DL) used when the network device 210 allocates the transmission resources to the terminal device 211 (or the terminal device 212). In mode B, as illustrated in FIG. 2b, the terminal devices (specifically, a vehicle-mounted terminal) select one resource from a resource pool for data transmission. In FIG. 2b, a bidirectional solid arrow indicates an SL between a terminal device 221 and a terminal device 222, and the network device 220 does not allocate transmission resources to the terminal device 221 or the terminal device 222.

In the 3GPP, D2D is divided into several stages for research, that is, proximity-based service (ProSe), V2X, further enhancements to LTE D2D (FeD2D), and multi-carrier. Prose is mainly used for public safety services. In Prose, the terminal device discontinuously sends or receives data on the SL by configuring a position of the resource pool in a time domain, for example, the resource pool is configured to be discontinuous in the time domain, thereby saving power. V2X is mainly used for relatively high-speed V2V and vehicle-to-human communication services. In V2X, since a vehicle-mounted system has a continuous power supply, the latency of data transmission is a main problem. Therefore, in a V2X system design, the terminal device is required to perform continuous transmission and reception. FeD2D is mainly used for scenarios with a low mobile speed and low power access. In FeD2D, the 3GPP concluded in a pre-research stage that the network device can configure a discontinuous reception (DRX) parameter for a remote terminal via a relay terminal. However, since this topic has not further entered a standardization stage, there is no conclusion as to the specifics of the DRX configuration. For the multi-carrier, the multi-carrier mechanism manifests itself in the capability of a UE to support packet segmentation for which a packet is sent by multiple carriers to improve the data transmission rate, and to support packet duplication for which two copies of a same packet are made and are sent by two carriers to improve transmission reliability, and to support enhanced multi-carrier reception at a receiving end.

On the basis of LTE V2X, NR V2X is not limited to broadcast scenarios, but is further expanded to unicast and groupcast scenarios. In NR V2X, similar to LTE V2X, two resource authorization modes, that is, mode A and mode B, can also be defined. Further, the terminal device may be in a hybrid mode where mode A and mode B can be used for resource acquisition. The resource acquisition is indicated through SL authorization. That is, the SL authorization indicates time-frequency positions of corresponding physical sidelink control channel (PSCCH) and physical sidelink shared channel (PSSCH) resources. In NR V2X, unlike LTE V2X, in addition to hybrid automatic repeat request (HARQ) retransmission automatically initiated by the terminal device without any feedback, feedback-based HARQ retransmission is introduced, which is not limited to unicast communication, but also includes groupcast communication.

In NR V2X, like LTE V2X, since the vehicle-mounted system has a continuous power supply, the latency of data transmission, instead of power efficiency, is the main problem. Therefore, in the V2X system design, the terminal device is required to perform continuous transmission and reception. An SL terminal will trigger an SL radio resource-control (RRC) reconfiguration process in the following scenarios: releasing the SL data bearer in unicast communication, establishing the SL data bearer in unicast communication, modifying the SL data bearer related configuration in unicast communication, releasing a PC5 relay radio link control (RLC) channel between the relay terminal and the remote terminal in Layer 2 in a terminal-to-network relay scenario, establishing the PC5 relay RLC channel between the relay terminal and the remote terminal in Layer 2 in the terminal-to-network relay scenario, modifying configuration parameters related to the PC5 relay RLC channel between the relay terminal and the remote terminal in Layer 2 in the terminal-to-network relay scenario, reconfiguring parameters related to NR SL measurement and reporting, reconfiguring the SL channel state information (CSI) reference signaling resources and CSI reporting latency, and reconfiguring SL DRX for a peer terminal.

FIG. 3 is a schematic flowchart of a method 300 for connection establishment according to an embodiment of the present disclosure. The method includes at least part of the following.

S310, when establishment of a first SL RRC connection between a first terminal and a second terminal is completed and establishment of a second SL RRC connection between the second terminal and a third terminal is completed, the first terminal establishes a third SL RRC connection with the third terminal via the second terminal.

FIG. 4 is a schematic flowchart of a method 400 for connection establishment according to an embodiment of the present disclosure. The method includes at least part of the following.

S410, a second terminal establishes a first SL RRC connection with a first terminal, and the second terminal establishes a second SL RRC connection with a third terminal.

In this embodiment, the first terminal, the second terminal, and the third terminal can all be terminal devices. Specifically, the second terminal can be a relay UE, and the relay UE is a terminal having a relay function and supporting the provision of relay services (or referred to as “data forwarding”) to a remote terminal. In this embodiment, the first terminal can be a source remote terminal, and the third terminal can be a target remote terminal. Alternatively, the first terminal can be a target remote terminal, and the third terminal can be a source remote terminal. Data relaying (or data forwarding) can be performed between the source remote terminal and the target remote terminal via a relay terminal. The source remote terminal, the relay terminal, and the target remote terminal are each within the coverage of a cell, and different terminals are within different coverage of cells. Alternatively, the source remote terminal, the relay terminal, and the target remote terminal are each outside the coverage of a cell. Alternatively, among the source remote terminal, the relay terminal, and the target remote terminal, some of the terminals are within the coverage of a cell, and the remaining terminals are outside the coverage of a cell.

Before the first terminal performs the operations at S310, the first terminal can further operate as follows. The first terminal establishes the first SL RRC connection with the second terminal. Correspondingly, the second terminal performs the operations at S410, that is, the second terminal establishes the first SL RRC connection with the first terminal, and the second terminal establishes the second SL RRC connection with the third terminal.

At S410, an execution order of establishing the first SL RRC connection between the second terminal and the first terminal by the second terminal and establishing the second SL RRC connection between the second terminal and the third terminal by the second terminal can be in no particular order. For example, the second terminal establishes the first SL RRC connection with the first terminal, and then the second terminal establishes the second SL RRC connection with the third terminal. For another example, the second terminal establishes the second SL RRC connection with the third terminal, and then the second terminal establishes the first SL RRC connection with the first terminal. For yet another example, the second terminal establishes the first SL RRC connection with the first terminal and the second SL RRC connection with the third terminal simultaneously. No matter which execution order is adopted, at S310, it is required that when the establishment of the first SL RRC connection between the first terminal and the second terminal is completed and the establishment of the second SL RRC connection between the second terminal and the third terminal is completed, the first terminal establishes the third SL RRC connection with the third terminal via the second terminal.

Firstly, the establishment of the first SL RRC connection between the first terminal and the second terminal is illustrated. It has been illustrated in the foregoing embodiments that the first terminal can be a source remote terminal or a target remote terminal. Therefore, the establishment of the first SL RRC connection herein can refer to the establishment of the first SL RRC connection between the source remote terminal and the relay terminal, or the establishment of the first SL RRC connection between the target remote terminal and the relay terminal.

In a possible embodiment, at a first terminal side, the first terminal establishes the first SL RRC connection with the second terminal as follows. The first terminal sends a first SL RRC reconfiguration message to the second terminal. When the first terminal has received a first SL RRC reconfiguration complete message from the second terminal, the first terminal determines that the establishment of the first SL RRC connection with the second terminal is completed.

At a second terminal side, the second terminal establishes the first SL RRC connection with the first terminal as follows. When the second terminal has received the first SL RRC reconfiguration message from the first terminal, the second terminal sends the first SL RRC reconfiguration complete message to the first terminal. The second terminal determines that the establishment of the first SL RRC connection with the first terminal is completed.

The SL RRC reconfiguration message includes at least one of: a resource pool related configuration, an SL discontinuous reception related configuration, an SL bearer configuration, or a terminal capability information indication. The resource pool related configuration can include a sending resource pool related configuration and/or a receiving resource pool related configuration.

Specifically, the first SL RRC reconfiguration message can include at least one of: a resource pool related configuration of the first terminal, an SL discontinuous reception related configuration of the first terminal, an SL bearer configuration of the first terminal, or a terminal capacity information indication of the first terminal.

The resource pool related configuration of the first terminal can include at least one of the following information: a sending resource pool related configuration of the first terminal or a receiving resource pool related configuration of the first terminal. The terminal capacity information indication of the first terminal can include a capacity information indication indicating whether the first terminal is capable of forwarding data via the relay terminal. It can be understood that more content can be included with respect to the capability of the first terminal, which is not listed in this embodiment.

The method can further include the following. When the first terminal sends the first SL RRC reconfiguration message to the second terminal, the first terminal starts a first timer. The first terminal can determine, based on whether the first timer expires and how the first timer is stopped, whether the establishment of the first SL RRC connection with the second terminal succeeds.

In an example, when the first terminal has received the first SL RRC reconfiguration complete message from the second terminal, the first terminal completes the establishment of the first SL RRC connection with the second terminal as follows. When the first terminal has received the first SL RRC reconfiguration complete message from the second terminal, the first terminal stops the first timer. The first terminal completes the establishment of the first SL RRC connection with the second terminal.

In this example, when the first terminal sends the first SL RRC reconfiguration message to the second terminal, the first terminal starts the first timer. When the first terminal receives the first SL RRC reconfiguration complete message from the second terminal before the first timer expires, the first terminal stops the first timer. Meanwhile, the first terminal can determine that the establishment of the first SL RRC connection is completed. The execution order of establishing the first SL RRC connection and establishing the second SL RRC connection is not limited in this example.

In an example, at the first terminal side, the method further includes the following. When the first terminal meets a first condition, the first terminal determines that a first SL RRC connection reconfiguration fails, where the first condition includes one of: the first timer expires; a first SL RRC reconfiguration failure message is received from the second terminal before the first timer expires; second indication information is received from the second terminal, where the second indication information indicates that the first timer is to be stopped; and the first terminal is to stop the establishment of the first SL RRC connection before the first timer expires.

The first timer expires, which can mean that after the first terminal starts the first timer and before the first timer expires, the first terminal has not received the first SL RRC reconfiguration complete message from the second terminal, has not received the first SL RRC reconfiguration failure message from the second terminal, has not received the second indication information from the second terminal, and has not determined to stop the establishment of the SL RRC connection. In this case, the first terminal can determine that the establishment of the first SL RRC connection reconfiguration fails.

The first SL RRC reconfiguration failure message is received from the second terminal before the first timer expires, which can mean that after the first terminal starts the first timer and before the first timer expires, the first terminal has received the first SL RRC reconfiguration failure message from the second terminal. In this case, the first terminal determines that the establishment of the first SL RRC connection reconfiguration fails, i.e. the establishment of the first SL RRC connection fails. The reason why the first SL RRC reconfiguration failure message is sent can be that in the case where the second terminal has received the first SL RRC reconfiguration message, if the second terminal fails to reconfigure the connection according to the first SL RRC reconfiguration message, the second terminal sends the first SL RRC reconfiguration failure message to the first terminal.

The second indication information can be sent to the first terminal when the second terminal determines that the quality of the RRC connection is not good currently. The second indication information can be carried by at least one of: an SL medium access control (MAC) control element (CE), a PC5-RRC message, or a sidelink control information (SCI).

The first terminal is to stop the establishment of the first SL RRC connection, which can be one of: a higher level of the first terminal determining to stop the establishment of the first SL RRC connection, and the first terminal having received tenth indication information from a first network device, where the tenth indication information indicates that the first terminal is to stop the establishment of the first SL RRC connection.

The higher level of the first terminal is to stop the establishment of the first SL RRC connection as follows. When the establishment duration of the establishment of the first SL RRC connection exceeds the latency requirement of service data to-be-sent, the higher level of the first terminal determines to stop the establishment of the SL RRC connection. Specifically, when the high layer has service data to be sent, the first terminal usually starts to establish the SL RRC connection, i.e., controls to start the establishment of the unicast connection. The service data to-be-sent has a corresponding latency requirement. When the high level of the first terminal determines that the duration of a current first timer is greater than the latency requirement corresponding to the service data to-be-sent, the high level of the first terminal can determine to stop the establishment of the SL RRC connection. Correspondingly, the first terminal directly controls to stop the first timer and determines that the establishment of the first SL RRC connection reconfiguration fails.

The first network device can be a network device that manages or serves the first terminal. Specifically, the first network device can be a first AN device, such as a first base station, a first gNB, a first eNB, etc., which is not listed herein. The tenth indication information can be carried by one of: a downlink control information (DCI), an RRC message, an MAC CE, etc. The first network device can determine to send the tenth indication information to the first terminal according to an actual situation or an actual requirement, which is not limited in embodiments.

When the first terminal determines that the first terminal meets any one of the first conditions, the first terminal can determine that the establishment of the first SL RRC connection reconfiguration fails.

In an example, at the second terminal side, the method further includes the following. When the second terminal sends the first SL RRC reconfiguration complete message to the first terminal, the second terminal starts a fourth timer.

After the second terminal starts the fourth timer when sending the first SL RRC reconfiguration complete message, the following processing manners can further be included. In a processing manner, when the fourth timer expires, the second terminal releases the first SL RRC connection. In other words, after the second terminal starts the fourth timer, if the second terminal has not received any information from the first terminal that can trigger the stop of the fourth timer, the fourth timer remains in an on-state (ON), the second terminal continues to determine whether the fourth timer expires, and until the second terminal determines that the fourth timer expires, the second terminal can determine to release the first SL RRC connection.

In another processing manner, when the first terminal has received the first SL RRC reconfiguration complete message from the second terminal, the first terminal sends first indication information to the second terminal, where the first indication information is used to confirm the establishment of the first SL RRC connection. Correspondingly, the second terminal determines that the first SL RRC connection with the first terminal is established as follows. When the second terminal has received the first indication information from the first terminal, the second terminal determines that the establishment of the first SL RRC connection with the first terminal is completed, where the first indication information is used to confirm the completion of the establishment of the first SL RRC connection.

Optionally, the method further includes the following. When the second terminal has received the first indication information from the first terminal, the second terminal stops the fourth timer. In other words, when the second terminal has received the first indication information from the first terminal, the second terminal can determine that the establishment of the first SL RRC connection with the first terminal is completed, and can stop the fourth timer simultaneously. The first indication information can be acknowledgement (ACK) information in RLC acknowledged mode (AM), which is used to confirm the successful establishment of the first SL RRC connection.

With this processing manner, the execution order of establishing the first SL RRC connection and establishing the second SL RRC connection is not limited.

In yet another processing manner, after the second terminal determines that the first SL RRC connection with the first terminal is established, the method further includes the following. When the second terminal sends a fifth SL RRC reconfiguration message to the third terminal, the second terminal stops the fourth timer. The second terminal receives a fifth SL RRC reconfiguration complete message from the third terminal, and the second terminal completes the establishment of the second SL RRC connection with the third terminal.

In this processing manner, the manner of determining that the establishment of the first SL RRC connection with the first terminal is completed can or cannot be based on the first indication information. For example, the second terminal has received the first indication information from the first terminal, and then the second terminal determines that the establishment of the first SL RRC connection with the first terminal is completed. Alternatively, when the second terminal sends the first SL RRC reconfiguration complete message to the first terminal, the second terminal determines that the establishment of the first SL RRC connection with the first terminal is completed.

With this processing manner, the execution order of establishing the first SL RRC connection and establishing the second SL RRC connection needs to be limited. Specifically, the execution order is limited to the establishment of the first SL RRC connection between the first terminal and the second terminal and then the establishment of the second SL RRC connection between the second terminal and the third terminal.

In another possible embodiment, at the first terminal side, the first terminal establishes the first SL RRC connection with the second terminal as follows. The first terminal receives a second SL RRC reconfiguration message from the second terminal. The first terminal sends a second SL RRC reconfiguration complete message to the second terminal, and the first terminal completes the establishment of the first SL RRC connection with the second terminal.

At the second terminal side, the second terminal establishes the first SL RRC connection with the first terminal as follows. The second terminal sends the second SL RRC reconfiguration message to the first terminal. When the second terminal has received the second SL RRC reconfiguration complete message from the first terminal, the second terminal completes the establishment of the first SL RRC connection with the first terminal.

The second SL RRC reconfiguration message can include at least one of: a resource pool related configuration of the second terminal, an SL discontinuous reception related configuration of the second terminal, an SL bearer configuration of the second terminal, or a terminal capacity information indication of the second terminal.

The resource pool related configuration of the second terminal can include at least one of the following information: a sending resource pool related configuration of the second terminal, or a receiving resource pool related configuration of the second terminal. The terminal capacity information indication of the second terminal can include a capacity information indication indicating whether the second terminal is capable of serving as the relay terminal for data forwarding.

The method can further include the following. When the second terminal sends the second SL RRC reconfiguration message to the first terminal, the second terminal starts a fifth timer. The second terminal can determine, based on whether the fifth timer expires and how the fifth timer is stopped, whether the establishment of the first SL RRC connection between the second terminal and the first terminal succeeds.

In an example, when the second terminal has received the second SL RRC reconfiguration complete message from the first terminal, the second terminal completes the establishment of the first SL RRC connection with the first terminal as follows. When the second terminal has received the second SL RRC reconfiguration complete message from the first terminal, the second terminal stops the fifth timer. The second terminal determines that the establishment of the first SL RRC connection with the first terminal is completed.

In this example, when the second terminal sends the second SL RRC reconfiguration message to the first terminal, the second terminal starts the fifth timer. When the second terminal receives the second SL RRC reconfiguration complete message from the first terminal before the fifth timer expires, the second terminal stops the fifth timer. Meanwhile, the second terminal can determine that the establishment of the first SL RRC connection is completed. The execution order of establishing the first SL RRC connection and establishing the second SL RRC connection is not limited in this example.

In an example, at the second terminal side, the method further includes the following. When the second terminal meets a third condition, the second terminal determines that the first SL RRC connection reconfiguration fails, where the third condition includes one of: the fifth timer expires; a second SL RRC reconfiguration failure message is received from the first terminal before the fifth timer expires; sixth indication information is received from the first terminal, where the sixth indication information indicates that the fifth timer is to be stopped; and the second terminal is to stop the establishment of the first SL RRC connection before the fifth timer expires.

The fifth timer expires, which can mean that after the second terminal starts the fifth timer and before the fifth timer expires, the second terminal has not received the second SL RRC reconfiguration complete message from the first terminal, has not received the second SL RRC reconfiguration failure message from the first terminal, has not received sixth indication information from the first terminal, and has not determined to stop the establishment of the SL RRC connection. In this case, the second terminal can determine that the establishment of the first SL RRC connection reconfiguration fails.

The second SL RRC reconfiguration failure message is received from the first terminal before the fifth timer expires, which can mean that after the second terminal starts the fifth timer and before the fifth timer expires, the second terminal has received the second SL RRC reconfiguration failure message from the first terminal. In this case, the second terminal determines that the establishment of the first SL RRC connection reconfiguration fails, i.e. the establishment of the first SL RRC connection fails.

The sixth indication information can be carried by at least one of: an SL MAC CE, a PC5-RRC message, or an SCI. The sixth indication information can be sent to the second terminal when the first terminal determines that the quality of the RRC connection is not good currently or when the first terminal determines to stop the establishment of the first SL RRC connection. A manner in which the first terminal determines to stop the establishment of the first SL RRC connection is the same as that of the foregoing embodiments, which is not repeated herein.

The second terminal is to stop the establishment of the first SL RRC connection, which can mean that the second terminal has received eleventh indication information from a second network device, where the eleventh indication information indicates that the second terminal is to stop the establishment of the SL RRC connection.

The second network device can be a network device that manages or serves the second terminal. Specifically, the second network device can be a second AN device, such as a second base station, a second gNB, a second eNB, etc., which is not listed herein. The second network device can be different from the first network device, and certainly in some scenarios, the second network device can be the same as the first network device, both of which are within the scope of protection of this embodiment. The eleventh indication information can be carried by one of: a DCI, an RRC message, an MAC CE, etc. The second network device can determine to send the eleventh indication information to the second terminal according to an actual situation or an actual requirement, which is not limited in embodiments.

When the second terminal determines that the second terminal meets any one of the third conditions, the second terminal can determine that the establishment of the first SL RRC connection reconfiguration fails.

In an example, at the first terminal side, the method further includes the following. When the first terminal sends the second SL RRC reconfiguration complete message to the second terminal, the first terminal starts a second timer.

After the first terminal starts the second timer when sending the second SL RRC reconfiguration complete message, the following processing manners can further be included.

In a processing manner, when the second timer expires, the first terminal releases the first SL RRC connection between the first terminal and the second terminal. In other words, after the first terminal starts the second timer, if the first terminal has not received any information that can trigger the stop of the second timer, the second timer remains ON, the first terminal continues to determine whether the second timer expires, and until the first terminal determines that the second timer expires, the first terminal can determine to release the first SL RRC connection.

It can be noted that when the first terminal determines to release the first SL RRC connection, the first terminal and/or the third terminal can reselect a new relay terminal as the second terminal, re-establish the first SL RRC connection, and re-establish the second SL RRC connection. Alternatively, when the first terminal determines to release the first SL RRC connection, the first terminal can also continue to try to establish the first SL RRC connection with the second terminal. For example, the first terminal sends the first SL RRC reconfiguration message to the second terminal again, or the first terminal waits to receive the second SL RRC reconfiguration message from the second terminal again, and all possible cases are not listed herein.

In another processing manner, when the second terminal has received the second SL RRC reconfiguration complete message from the first terminal, the second terminal sends third indication information to the first terminal, where the third indication information is used to confirm the completion of the establishment of the first SL RRC connection. Correspondingly, the first terminal completes the establishment of the first SL RRC connection with the second terminal as follows. The first terminal receives the third indication information from the second terminal, stops the second timer, and completes the establishment of the first SL RRC connection with the second terminal, where the third indication information is used to confirm the completion of the establishment of the first SL RRC connection.

The third indication information can be ACK information in RLC AM, which is used to confirm the successful establishment of the first SL RRC connection.

With this processing manner, the execution order of establishing the first SL RRC connection and establishing the second SL RRC connection is not limited.

In yet another processing manner, the first terminal completes the establishment of the first SL RRC connection with the second terminal as follows. The first terminal receives a first message from the second terminal, where the first message is related to a third SL RRC reconfiguration message sent to the second terminal from the third terminal. The first terminal stops the second timer, determines that the establishment of the first SL RRC connection between the first terminal and the second terminal is completed, and determines that the establishment of the second SL RRC connection between the second and the third terminal is completed.

The third SL RRC reconfiguration message can include at least one of: a resource pool related configuration of the third terminal, an SL discontinuous reception related configuration of the third terminal, an SL bearer configuration of the third terminal, or a terminal capacity information indication of the third terminal. The resource pool related configuration of the third terminal can include at least one of the following information: a sending resource pool related configuration of the third terminal, or a receiving resource pool related configuration of the third terminal. The terminal capability information indication of the third terminal can include a capacity information indication indicating whether the third terminal is capable of forwarding data through the relay terminal. It can be understood that more content can be included regarding the capability of the third terminal, which is not listed in this embodiment.

The first message can include one of: the third SL RRC reconfiguration message, and a part of information in the third SL RRC reconfiguration message. The first message can be forwarded to the first terminal after the second terminal has received the third SL RRC reconfiguration message from the third terminal. The first message can be all or a part of the information in the third SL RRC reconfiguration message.

With this processing manner, the execution order of establishing the first SL RRC connection and establishing the second SL RRC connection needs to be limited. Specifically, the execution order is limited to the establishment of the first SL RRC connection between the first terminal and the second terminal and then the establishment of the second SL RRC connection between the second terminal and the third terminal.

In this processing manner, the second terminal generates and sends the first message to the first terminal based on the third SL RRC reconfiguration message as follows. When the second terminal determines that the establishment of the first SL RRC connection with the first terminal is completed, the second terminal starts to establish the second SL RRC connection with the third terminal. When the second terminal determines that the establishment of the second SL RRC connection with the third terminal is completed, the second terminal receives the third SL RRC reconfiguration message from the third terminal. The second terminal generates and sends the first message to the first terminal based on the third SL RRC reconfiguration message. Correspondingly, after the first terminal has received the second SL RRC reconfiguration complete message from the second terminal, the first terminal can start the second timer and continuously wait to receive the first message forwarded by the second terminal. When the first terminal has received the first message, the first terminal can determine that the establishment of the first SL RRC connection succeeds and that the establishment of the second SL RRC connection succeeds, and therefore can control to stop the second timer.

It can be noted that the second terminal side generates and sends the first message to the first terminal based on the third SL RRC reconfiguration message as follows. The second terminal directly takes the third SL RRC reconfiguration message as the first message, i.e., the second terminal forwards the third SL RRC reconfiguration message sent to the first terminal from the third terminal. Alternatively, the second terminal takes a part of the information in the third SL RRC reconfiguration message as the first message, and the second terminal forwards the first message to the first terminal.

The second terminal takes a part of the information in the third SL RRC reconfiguration message as the first message, which can mean that the second terminal selects a part of the information from the third SL RRC reconfiguration message as the first message. The selection manner can be determined according to the actual situation, for example, pre-configuring that only the receiving resource pool related configuration of the third terminal and/or the discontinuous reception related configuration of the third terminal need to be sent to the first terminal, etc., which is only an exemplary illustration, and in actual processing, another part of the information can be selected as the first message, and all possible cases are not listed herein.

The establishment of the second SL RRC connection is illustrated in the following. It has been illustrated in the foregoing embodiments that the third terminal can be a source remote terminal or can be a target remote terminal. Therefore, the establishment of the second SL RRC connection herein can refer to the establishment of the second SL RRC connection between the source remote terminal and the relay terminal, or refer to the establishment of the second SL RRC connection between the target remote terminal and the relay terminal. It can be noted that when the establishment of the first SL RRC connection refers to the establishment of the first SL RRC connection between the source remote terminal and the relay terminal, the establishment of the second SL RRC connection refers to the establishment of the second SL RRC connection between the target remote terminal and the relay terminal. When the establishment of the first SL RRC connection refers to the establishment of the first SL RRC connection between the target remote terminal and the relay terminal, the establishment of the second SL RRC connection refers to the establishment of the second SL RRC connection between the source remote terminal and the relay terminal.

In a possible embodiment, at the second terminal side, the second terminal establishes the second SL RRC connection with the third terminal as follows. The second terminal sends the fifth SL RRC reconfiguration message to the third terminal. When the second terminal has received the fifth SL RRC reconfiguration complete message from the third terminal, the second terminal completes the establishment of the second SL RRC connection with the third terminal.

At a third terminal side, the third terminal establishes the second SL RRC connection with the second terminal as follows. When the third terminal has received the fifth SL RRC reconfiguration message from the second terminal, the third terminal sends the fifth SL RRC reconfiguration complete message to the second terminal, and determines that the establishment of the second SL RRC connection with the second terminal is completed.

Specifically, the fifth SL RRC reconfiguration message can include at least one of: a resource pool related configuration of the second terminal, an SL discontinuous reception related configuration of the second terminal, an SL bearer configuration of the second terminal, or a terminal capacity information indication of the second terminal.

The method can further include the following. When the second terminal sends the fifth SL RRC reconfiguration message to the third terminal, the second terminal starts a sixth timer. The second terminal can determine, based on whether the sixth timer expires and how the sixth timer is stopped, whether the establishment of the second SL RRC connection with the third terminal succeeds.

In an example, when the second terminal has received the fifth SL RRC reconfiguration complete message from the third terminal, the second terminal completes the establishment of the second SL RRC connection with the third terminal as follows. When the second terminal has received the fifth SL RRC reconfiguration complete message from the third terminal, the second terminal stops the sixth timer. The second terminal determines that the establishment of the second SL RRC connection with the third terminal is completed.

In this example, when the second terminal sends the fifth SL RRC reconfiguration message to the third terminal, the second terminal starts the sixth timer. When the second terminal receives the fifth SL RRC reconfiguration complete message from the third terminal before the sixth timer expires, the second terminal stops the sixth timer. Meanwhile, the second terminal can determine that the establishment of the first SL RRC connection succeeds.

In an example, at the second terminal side, the method includes the following. When the second terminal meets a fourth condition, the second terminal determines that the second SL RRC connection reconfiguration fails, where the fourth condition includes one of: the sixth timer expires; a fifth SL RRC reconfiguration failure message is received from the third terminal before the sixth timer expires; eighth indication information is received from the third terminal, where the eighth indication information indicates that the sixth timer is to be stopped; and the second terminal is to stop the establishment of the second SL RRC connection before the sixth timer expires.

The sixth timer expires, which can mean that after the second terminal starts the sixth timer and before the sixth timer expires, the second terminal has not received the fifth SL RRC reconfiguration complete message from the third terminal, has not received the fifth SL RRC reconfiguration failure message from the third terminal, has not received the eighth indication information from the third terminal, and has not determined to stop the establishment of the SL RRC connection. In this case, the second terminal can determine that the establishment of the second SL RRC connection reconfiguration fails, i.e., the establishment of the second SL RRC connection fails.

The fifth SL RRC reconfiguration failure message is received from the third terminal before the sixth timer expires, which can mean that after the second terminal starts the sixth timer and before the sixth timer expires, the second terminal has received the fifth SL RRC reconfiguration failure message from the second terminal. In this case, the second terminal determines that the establishment of the second SL RRC connection reconfiguration fails, i.e. the establishment of the second SL RRC connection fails.

The eighth indication information can be carried by at least one of: an SL MAC CE, a PC5-RRC message, or an SCI. The eighth indication information can be sent to the second terminal when the third terminal determines that the quality of the RRC connection is not good currently or when the third terminal determines to stop the establishment of the second SL RRC connection. A manner in which the third terminal determines to stop the establishment of the second SL RRC connection is similar to the descriptions of the manner in which the first terminal determines to stop the establishment of the first SL RRC connection, which is not repeated herein.

The second terminal is to stop the establishment of the second SL RRC connection, which can mean that the second terminal has received twelfth indication information from the second network device, where the twelfth indication information indicates that the second terminal is to stop the establishment of the second SL RRC connection.

The descriptions of the second network device are the same as those of the foregoing embodiments, which are not repeated herein. The second network device determining to stop the establishment of the second SL RRC connection is similar to the descriptions of the second network device determining to stop the establishment of the first SL RRC connection, which is not repeated herein.

When the second terminal determines that the second terminal meets any one of the fourth conditions, the second terminal can determine that the establishment of the second SL RRC connection reconfiguration fails.

It can be noted that at the third terminal side, the method can further include the following. When the third terminal sends the fifth SL RRC reconfiguration complete message to the second terminal, the third terminal starts an eighth timer.

In a processing manner, when the eighth timer expires, the third terminal releases the second SL RRC connection. This processing manner is similar to that the first terminal releases the first SL RRC connection between the first terminal and the second terminal when the second timer expires, which is not repeated herein.

In another processing manner, when the second terminal has received the fifth SL RRC reconfiguration complete message from the third terminal, the second terminal sends seventh indication information to the third terminal, where the seventh indication information is used to confirm the completion of the establishment of the second SL RRC connection. Correspondingly, the third terminal determines that the establishment of the second SL RRC connection with the second terminal is completed as follows. The third terminal receives the seventh indication information from the second terminal, stops the eighth timer, and determines that the establishment of the second SL RRC connection with the second terminal is completed.

The seventh indication information can be ACK information in RLC AM, which is used to confirm the successful establishment of the second SL RRC connection. This processing manner is similar to the processing manner after the first terminal has received the third indication information from the second terminal, which is not repeated herein.

In yet another processing manner, the third terminal determines that the establishment of the second SL RRC connection with the second terminal is completed as follows. The third terminal receives a second message from the second terminal. The third terminal stops the eighth timer, determines that the establishment of the first SL RRC connection between the first terminal and the second terminal is completed, and determines that the establishment of the second SL RRC connection with the second terminal is completed. Correspondingly, the method further includes the following. The second terminal receives a fourth SL RRC reconfiguration message from the first terminal. The second terminal sends the second message to the third terminal, where the second message is related to the fourth SL RRC reconfiguration message.

The fourth SL RRC reconfiguration message can include at least one of: a resource pool related configuration of the first terminal, an SL discontinuous reception related configuration of the first terminal, an SL bearer configuration of the first terminal, or a terminal capability information indication of the first terminal.

The second message can include one of: the fourth SL RRC reconfiguration message, and a part of the information in the fourth SL RRC reconfiguration message. The second message can be forwarded to the third terminal after the second terminal has received the fourth SL RRC reconfiguration message from the first terminal. The second message can be all or a part of the information in the fourth SL RRC reconfiguration message.

With this processing manner, the execution order of establishing the first SL RRC connection and establishing the second SL RRC connection needs to be limited. Specifically, the execution order is limited to the establishment of the second SL RRC connection between the second terminal and the third terminal and then the establishment of the first SL RRC connection between the second terminal and the first terminal.

In this processing manner, the processing of the second terminal generates and sends the second message to the third terminal based on the fourth SL RRC reconfiguration message is similar to the processing of the second terminal generates and sends the first message to the first terminal based on the third SL RRC reconfiguration message, which is not repeated herein. Correspondingly, the processing after the third terminal has received the second message is similar to the processing after the first terminal has received the first message, which is not repeated herein.

In another possible embodiment, at the third terminal side, the third terminal establishes the second SL RRC connection with the second terminal as follows. The third terminal sends a sixth SL RRC reconfiguration message to the second terminal. When the third terminal has received a sixth SL RRC reconfiguration complete message from the second terminal, the third terminal determines that the establishment of the second SL RRC connection with the second terminal is completed.

At the second terminal side, the second terminal establishes the second SL RRC connection with the third terminal as follows. When the second terminal has received the sixth SL RRC reconfiguration message from the third terminal, the second terminal sends the sixth SL RRC reconfiguration complete message to the third terminal. The second terminal completes the establishment of the second SL RRC connection with the third terminal.

Specifically, the sixth SL RRC reconfiguration message can include at least one of: a resource pool related configuration of the third terminal, an SL discontinuous reception related configuration of the third terminal, an SL bearer configuration of the third terminal, or a terminal capacity information indication of the third terminal. The resource pool related configuration of the third terminal can include at least one of the following information: a sending resource pool related configuration of the third terminal, or a receiving resource pool related configuration of the third terminal. The terminal capability information indication of the third terminal can include a capacity information indication indicating whether the third terminal is capable of forwarding data via the relay terminal.

In an example, at the third terminal side, the method can further include the following. When the third terminal sends the sixth SL RRC reconfiguration message to the second terminal, the third terminal starts a ninth timer. The third terminal can determine, based on whether the ninth timer expires and how the ninth timer is stopped, whether the establishment of the second SL RRC connection with the second terminal succeeds.

Optionally, when the third terminal has received the sixth SL RRC reconfiguration complete message from the second terminal, the third terminal determines that the establishment of the second SL RRC connection with the second terminal is completed as follows. When the third terminal has received the sixth SL RRC reconfiguration complete message from the second terminal, the third terminal stops the ninth timer. The third terminal determines that the establishment of the second SL RRC connection with the second terminal is completed.

Optionally, when the third terminal meets a fifth condition, the third terminal determines that the second SL RRC connection reconfiguration fails, where the fifth condition includes one of: the ninth timer expires; a sixth SL RRC reconfiguration failure message is received from the second terminal before the ninth timer expires; twelfth indication information is received from the second terminal, where the twelfth indication information indicates that the ninth timer is to be stopped; and the third terminal is to stop the establishment of the second SL RRC connection before the ninth timer expires.

Specifically, a manner in which the third terminal determines whether the establishment of the second SL RRC connection with the second terminal succeeds is similar to the manner in which the first terminal starts the first timer when sending the first SL RRC reconfiguration message to the second terminal, and thus the first terminal determines whether the establishment of the first SL RRC connection with the second terminal succeeds, which is not repeated herein.

In an example, at the second terminal side, the method further includes the following. When the second terminal sends the sixth SL RRC reconfiguration complete message to the third terminal, the second terminal starts a seventh timer.

After the second terminal starts the seventh timer when sending the sixth SL RRC reconfiguration complete message, the following processing manners can further be included.

In a processing manner, when the seventh timer expires, the second terminal releases the second SL RRC connection. In other words, after the second terminal starts the seventh timer, if the second terminal has not received any information from the third terminal that can trigger the stop of the seventh timer, the seventh timer remains ON, the second terminal continues to determine whether the seventh timer expires, and until the second terminal determines that the seventh timer expires, the second terminal determines to release the second SL RRC connection.

In another processing manner, when the third terminal has received the sixth SL RRC reconfiguration complete message from the second terminal, the third terminal sends ninth indication information to the second terminal, where the ninth indication information is used to confirm the completion of the establishment of the second SL RRC connection. Correspondingly, the second terminal completes the establishment of the second SL RRC connection with the third terminal as follows. When the second terminal has received the ninth indication information from the third terminal, the second terminal completes the establishment of the second SL RRC connection with the third terminal, where the ninth indication information is used to confirm the completion of the establishment of the second SL RRC connection.

Optionally, the method further includes the following. When the second terminal has received the ninth indication information from the third terminal, the second terminal stops the seventh timer. In other words, as soon as the second terminal has received the ninth indication information from the third terminal, the second terminal can determine that the establishment of the second SL RRC connection with the third terminal is completed, and can stop the seventh timer simultaneously. The ninth indication information can be ACK information in RLC AM, which is used to confirm the successful establishment of the second SL RRC connection.

With this processing manner, the execution order of establishing the first SL RRC connection and establishing the second SL RRC connection is not limited.

In yet another processing manner, after the second terminal completes the establishment of the second SL RRC connection with the third terminal, the method further includes the following. When the second terminal sends the second SL RRC reconfiguration message to the first terminal, the second terminal stops the seventh timer.

In this processing manner, the manner in which the second terminal determines that the second SL RRC connection with the third terminal is established can or cannot be based on the ninth indication information. For example, the second terminal has received the ninth indication information from the third terminal, and then the second terminal determines that the second SL RRC connection with the third terminal is established. Alternatively, when the second terminal sends the sixth SL RRC reconfiguration complete message to the third terminal, the second terminal determines that the second SL RRC connection with the third terminal is established.

With this processing manner, the execution order of establishing the first SL RRC connection and establishing the second SL RRC connection needs to be limited. Specifically, the execution order is limited to the establishment of the second SL RRC connection between the second terminal and the third terminal and then the establishment of the first SL RRC connection between the first terminal and the second terminal.

The establishment of the first SL RRC connection and the establishment of the second SL RRC connection have been illustrated in multiple foregoing embodiments respectively. In actual processing, in some scenarios, the execution order of establishing the first SL RRC connection and establishing the second SL RRC connection is not limited, while in some scenarios, the execution order of establishing the first SL RRC connection and establishing the second SL RRC connection needs to be limited. Scenarios in which the execution order needs to be limited will be illustrated as follows.

Scenario 1, the first terminal sends the first SL RRC reconfiguration message to the second terminal, and then completes the establishment of the first SL RRC connection. In a processing manner, only when the second terminal sends the fifth SL RRC reconfiguration message to the third terminal, the second terminal will stop the fourth timer. With this processing, it needs to be limited that the second terminal side determines that the establishment of the first SL RRC connection is completed and then the second terminal sends the fifth SL RRC reconfiguration message to the third terminal, i.e., the second terminal establishes the second SL RRC connection. It can be understood that in this scenario, it can also be limited that the third terminal does not actively send the SL RRC reconfiguration message and the first terminal actively sends the first SL RRC reconfiguration message.

Scenario 2, the second terminal sends the second SL RRC reconfiguration message to the first terminal, and then completes the establishment of the first SL RRC connection. In a processing manner, the first terminal needs to receive the first message from the second terminal, so that the first terminal stops the second timer, determines that the establishment of the first SL RRC connection between the first terminal and the second terminal is completed, and determines that the establishment of the second SL RRC connection between the second terminal and the third terminal is completed. Therefore, it needs to be limited that the second terminal side determines that the establishment of the first SL RRC connection succeeds and then establishes the second SL RRC connection.

Scenario 3, the second terminal sends the fifth SL RRC reconfiguration message to the third terminal, and then establishes the second SL RRC connection. In a processing manner, the third terminal needs to receive the second message from the second terminal, so that the third terminal stops the eighth timer, determines that the establishment of the first SL RRC connection between the first terminal and the second terminal is completed, and determines that the establishment of the second SL RRC connection between the second terminal and the third terminal is completed. Therefore, it needs to be limited that the second terminal side determines that the establishment of the second SL RRC connection succeeds and then establishes the first SL RRC connection.

Scenario 4, the second terminal receives the sixth SL RRC reconfiguration message from the third terminal, and then completes the establishment of the second SL RRC connection. In a processing manner, only when the second terminal sends the second SL RRC reconfiguration message to the first terminal, the second terminal will stop the seventh timer. Therefore, it needs to be limited that the second terminal side determines that the establishment of the second SL RRC connection succeeds, and then the second terminal sends the second SL RRC reconfiguration message to the first terminal. It can be understood that in this scenario, it can also be limited that the first terminal does not actively send the SL RRC reconfiguration message and the third terminal actively sends the sixth SL RRC reconfiguration message.

In an embodiment, a manner in which the first terminal determines whether the second SL RRC connection between the second terminal and the third terminal is established is illustrated as follows.

Manner 1, at the first terminal side, the method can further include the following. The first terminal receives fourth indication information from the second terminal, where the fourth indication information indicates whether the establishment of the second SL RRC connection between the second terminal and the third terminal is completed. Correspondingly, at the second terminal side, the method can further include the following. When the first SL RRC connection between the second terminal and the first terminal is established, the second terminal sends the fourth indication information to the first terminal, where the fourth indication information indicates whether the establishment of the second SL RRC connection between the second terminal and the third terminal is completed.

At the first terminal side, the method can further include the following. When the fourth indication information indicates that the establishment of the second SL RRC connection between the second terminal and the third terminal is completed, the first terminal determines that the establishment of the second SL RRC connection between the second terminal and the third terminal is completed. Alternatively, at the first terminal side, the method can further include the following. When the fourth indication information indicates that establishment of the second SL RRC connection between the second terminal and the third terminal fails, the first terminal releases the first SL RRC connection with the second terminal.

As for the processing at the second terminal side, it is also noted that when the second terminal determines that the establishment of the first SL RRC connection succeeds or fails, the second terminal can determine whether the first SL RRC connection between the second terminal and the first terminal is established. When the establishment of the first SL RRC connection between the second terminal and the first terminal has not started, the second terminal cannot send the fourth indication information but can start to establish the first SL RRC connection. When the establishment of the first SL RRC connection between the second terminal and the first terminal succeeds, the second terminal can send the fourth indication information.

It is also noted that for the first SL RRC connection and the second SL RRC connection, it is possible that one is successfully established and the other fails to be established. In this case, the failed SL RRC connection can be re-established, or a new relay terminal can be re-selected as a new second terminal, and then the first SL RRC connection can be re-established between the first terminal and the new second terminal and the second SL RRC connection can be re-established between the third terminal and the new second terminal. Alternatively, both the first SL RRC connection and the second SL RRC connection fail to be established. In this case, a new relay terminal can be re-selected as a new second terminal, and then the first SL RRC connection can be re-established between the first terminal and the new second terminal and the second SL RRC connection can be re-established between the third terminal and the new second terminal.

Manner 2, the first terminal receives the first message from the second terminal, and determines that the second SL RRC connection between the second terminal and the third terminal is established, where the first message is related to the third SL RRC reconfiguration message sent to the second terminal from the third terminal.

In this manner, after the first terminal sends the second SL RRC reconfiguration complete message to the second terminal, the first terminal does not perform any processing. Until the first terminal has received the first message from the second terminal, the first terminal can determine that the establishment of the second SL RRC connection between the second terminal and the third terminal succeeds, and can determine that the first SL RRC connection between the first terminal and the second terminal is established. Alternatively, after the first terminal sends the second SL RRC reconfiguration complete message to the second terminal, the first terminal has received the third indication information from the second terminal, and then the first terminal determines that the first SL RRC connection between the first terminal and the second terminal is established. Then, the first terminal keeps waiting unit the first terminal receives the first message from the second terminal, and then the first terminal can determine that the establishment of the second SL RRC connection between the second terminal and the third terminal succeeds. The descriptions of the third indication information and the first message are the same as those of the foregoing embodiments, which are not repeated herein.

For a manner in which the third terminal determines whether the second SL RRC connection between the third terminal and the second terminal is established, reference can be made to the foregoing embodiments, which is not repeated herein. For a manner in which the third terminal determines that the first SL RRC connection between the second terminal and the first terminal is established, the description is as follows.

Manner 3, at the third terminal side, the method can further include the following. The first terminal receives the seventh indication information from the second terminal, where the seventh indication information indicates whether the establishment of the first SL RRC connection between the second terminal and the first terminal succeeds. Correspondingly, at the second terminal side, when the second SL RRC connection between the second terminal and the third terminal is established, the second terminal sends the seventh indication information to the third terminal, where the seventh indication information indicates whether the first SL RRC connection is established.

Further, the processing at the third terminal is similar to the processing in which the first terminal has received the fourth indication information in Manner 1, which is not repeated herein. Further, the processing at the second terminal is similar to the processing that the second terminal sends the fourth indication information in Manner 1, which is not repeated herein.

Manner 4, the third terminal receives the second message from the second terminal, and determines that the second SL RRC connection between the third terminal and the second terminal is established, where the second message is related to the fourth SL RRC reconfiguration message sent to the second terminal from the first terminal. The specific processing of the third terminal is similar to the processing after the first terminal receives the first message from the second terminal in Manner 2, which is not repeated herein.

Based on the above embodiments, the first terminal can determine whether the establishment of the first SL RRC connection between the first terminal and the second terminal succeeds, and can determine whether the establishment of the second SL RRC connection between the second terminal and the third terminal succeeds. Further, when the first terminal determines that the first SL RRC connection between the first terminal and the second terminal is established and determines that the second SL RRC connection between the second terminal and the third terminal is established, the first terminal will establish the third SL RRC connection with the third terminal. Similarly, the third terminal can determine whether the establishment of the first SL RRC connection between the first terminal and the second terminal succeeds, and can determine whether the establishment of the second SL RRC connection between the second terminal and the third terminal succeeds. Further, when the third terminal determines that the first SL RRC connection between the first terminal and the second terminal is established and determines that the second SL RRC connection between the second terminal and the third terminal is established, the third terminal will establish the third SL RRC connection with the first terminal.

The establishment of the third SL RRC connection is illustrated as follows.

In a possible embodiment, the first terminal sends the fourth SL RRC reconfiguration message to trigger the start of the establishment of the third SL RRC connection between the first terminal and the third terminal.

At the first terminal side, the first terminal establishes the third SL RRC connection with the third terminal via the second terminal as follows. The first terminal sends the fourth SL RRC reconfiguration message to the second terminal, where the fourth SL RRC reconfiguration message is used by the second terminal to determine the second message, and the second message is to be sent by the second terminal to the third terminal. When the first terminal has received the fourth SL RRC reconfiguration complete message from the third terminal via the second terminal, the first terminal completes the establishment of the third SL RRC connection with the third terminal via the second terminal.

Correspondingly, at the second terminal side, the method can include the following. When the establishment of the first SL RRC connection between the second terminal and the first terminal is completed and the establishment of the second SL RRC connection between the second terminal and the third terminal is completed, the second terminal receives the fourth SL RRC reconfiguration message from the first terminal. The second terminal sends the second message to the third terminal, where the second message is related to the fourth SL RRC reconfiguration message. The second terminal forwards the fourth SL RRC reconfiguration complete message to the first terminal sent from the third terminal.

At the third terminal side, the method can include the following. When the third terminal has received the second message from the second terminal, the third terminal sends the fourth SL RRC reconfiguration complete message to the first terminal via the second terminal. The third terminal completes the establishment of the third SL RRC connection with the first terminal via the second terminal.

At the first terminal side, the method further includes the following. When the first terminal sends the fourth SL RRC reconfiguration message to the second terminal, the first terminal starts a third timer. The first terminal can determine, based on whether the third timer expires and how the third timer is stopped, whether the establishment of the third SL RRC connection with the second terminal succeeds.

In an example, when the first terminal has received the fourth SL RRC reconfiguration complete message from the third terminal via the second terminal, the first terminal completes the establishment of the third SL RRC connection with the third terminal via the second terminal as follows. When the first terminal has received the fourth SL RRC reconfiguration complete message from the third terminal via the second terminal, the first terminal stops the third timer. The first terminal determines that the establishment of the third SL RRC connection with the third terminal is completed via the second terminal.

In this example, when the first terminal receives the fourth SL RRC reconfiguration complete message from the third terminal via the second terminal before the third timer expires, the first terminal stops the third timer. Meanwhile, the first terminal can determine that the establishment of the third SL RRC connection succeeds.

In an example, at the first terminal side, the method further includes the following. When the first terminal meets a second condition, the first terminal determines that the third SL RRC connection reconfiguration fails, where the second condition includes one of: the third timer expires; a fourth SL RRC reconfiguration failure message is received from the third terminal before the third timer expires; fifth indication information is received from the third terminal, where the fifth indication information indicates that the third timer is to be stopped; and the first terminal is to stop the establishment of the third SL RRC connection before the third timer expires.

The third timer expires, which can mean that after the first terminal starts the third timer and before the third timer expires, the first terminal has not received any message that can trigger the stop of the third timer. In this case, the first terminal can determine that the establishment of the third SL RRC connection reconfiguration fails, i.e., the establishment of the third SL RRC connection fails.

The fourth SL RRC reconfiguration failure message is received from the third terminal before the third timer expires, which can mean that after the first terminal starts the third timer and before the third timer expires, the first terminal has received the fourth SL RRC reconfiguration failure message which is sent from the third terminal and forwarded by the second terminal. In this case, the first terminal determines that the establishment of the third SL RRC connection reconfiguration fails.

The fourth indication information can be sent to the first terminal via the second terminal when the third terminal determines that the quality of the RRC connection is not good currently. The fourth indication information can be carried by at least one of: an SL MAC CE, a PC5-RRC message, or an SCI.

The first terminal determining to stop the establishment of the third SL RRC connection is similar to the first terminal determining to stop the establishment of the first SL RRC connection in the foregoing embodiment, which is not repeated herein.

In an example, at the third terminal side, the method further includes the following. When the third terminal sends the fourth SL RRC reconfiguration complete message to the first terminal via the second terminal, the third terminal starts a tenth timer.

In a processing manner, when the tenth timer expires, the third terminal releases the third SL RRC connection.

In another processing manner, when the first terminal has received the fourth SL RRC reconfiguration complete message from the third terminal via the second terminal, the first terminal sends thirteenth indication information to the second terminal, where the thirteenth indication information is used to confirm the completion of the establishment of the third SL RRC connection. Correspondingly, the third terminal determines that the establishment of the third SL RRC connection with the first terminal is completed as follows. The third terminal receives the thirteenth indication information which is sent from the first terminal and forwarded by the second terminal, where the thirteenth indication information is used to confirm the completion of the establishment of the third SL RRC connection. The third terminal determines that the establishment of the third SL RRC connection with the first terminal is completed.

Optionally, the method further includes the following. When the third terminal has received the thirteenth indication information which is sent from the first terminal and forwarded by the second terminal, the third terminal stops the tenth timer. The thirteenth indication information can be ACK information in RLC AM, which is used to confirm the successful establishment of the third SL RRC connection.

In a possible embodiment, the third terminal sends the third SL RRC reconfiguration message to trigger the start of the establishment of the third SL RRC connection between the first terminal and the third terminal.

At the first terminal side, if the first terminal determines that the establishment of the second SL RRC connection is completed in the foregoing processing in such a manner that: when the fourth indication information indicates the establishment of the second SL RRC connection between the second terminal and the third terminal is completed, the first terminal determines that the establishment of the second SL RRC connection between the second terminal and the third terminal is completed, then the first terminal establishes the third SL RRC connection with the third terminal via the second terminal as follows. The first terminal receives the first message from the second terminal. The first terminal sends the third SL RRC reconfiguration complete message to the third terminal via the second terminal, and the first terminal completes the establishment of the third SL RRC connection with the third terminal via the second terminal.

If the first terminal determines that the establishment of the second SL RRC connection is completed in the foregoing processing in such a manner that: the first terminal receives the first message from the second terminal and determines that the second SL RRC connection between the second terminal and the third terminal is established, then the first terminal establishes the third SL RRC connection with the third terminal via the second terminal as follows. When the first terminal has received the first message from the second terminal, the first terminal sends the third SL RRC reconfiguration complete message to the third terminal via the second terminal. The first terminal completes the establishment of the third SL RRC connection with the third terminal via the second terminal.

At the second terminal side, the method can include the following. When the establishment of the first SL RRC connection between the second terminal and the first terminal is completed and the establishment of the second SL RRC connection between the second terminal and the third terminal is completed, the second terminal receives the third SL RRC reconfiguration message from the third terminal. The second terminal sends the first message to the first terminal, where the first message is related to the third SL RRC reconfiguration message. The second terminal forwards the third SL RRC reconfiguration complete message sent to the third terminal from the first terminal.

At the third terminal side, the third terminal establishes the third SL RRC connection with the first terminal via the second terminal as follows. The third terminal sends the third SL RRC reconfiguration message to the second terminal, where the third RRC reconfiguration message is used by the second terminal to determine the first message, and the first message is to be sent by the second terminal to the first terminal. When the third terminal has received the third SL RRC reconfiguration complete message from the first terminal via the second terminal, the third terminal completes the establishment of the third SL RRC connection with the first terminal via the second terminal.

At the third terminal side, after the third SL RRC reconfiguration message is sent, the method can further include starting an eleventh timer. The third terminal can determine, based on whether the eleventh timer expires and how the eleventh timer is stopped, whether the establishment of the third SL RRC connection with the first terminal succeeds. The processing in which the third terminal determines, according to the eleventh timer, whether the establishment of the third SL RRC connection with the first terminal is similar to the processing in which the first terminal determines, according to the third timer, whether the establishment of the third SL RRC connection succeeds in the foregoing embodiment, which is not repeated herein.

At the first terminal side, the method can further include the following. When the first terminal sends the fourth SL RRC reconfiguration complete message to the third terminal via the second terminal, the first terminal determines that the establishment of the third SL RRC connection succeeds. Alternatively, when the first terminal sends the fourth SL RRC reconfiguration complete message to the third terminal via the second terminal, the first terminal can start a twelfth timer. Correspondingly, when the twelfth timer expires, the first terminal releases the third SL RRC connection. Alternatively, when the first terminal has received fourteenth indication information from the third terminal via the second terminal, the first terminal stops the twelfth timer. The first terminal determines that the establishment of the third SL RRC connection succeeds. The fourteenth indication information is used to confirm the establishment of the third SL RRC connection.

Based on the foregoing processing, the establishment of the third SL RRC connection between the first terminal and the third terminal can be completed via the second terminal.

In a possible embodiment, when the first terminal has received the second SL RRC configuration message, the method can further include that the first terminal sends the second SL RRC configuration message to the first network device. Additionally/alternatively, when the first terminal has received the first message, the method can further include that the first terminal sends the first message to the first network device.

The specific description of the first network device is the same as that of the foregoing embodiments, which is not repeated herein. Correspondingly, when the first network device has received the second SL RRC configuration message and/or the first message, the first network device can also send to the first terminal an updated SL RRC reconfiguration message corresponding to the first terminal. The updated SL RRC reconfiguration message corresponding to the first terminal can be sent to the first terminal when the first network device determines that changes occur in at least one of: the resource pool related configuration of the first terminal, the SL discontinuous reception related configuration of the first terminal, the SL bearer configuration of the first terminal, or the terminal capacity information indication of the first terminal.

In a possible embodiment, after the second terminal has received the first SL RRC reconfiguration message from the first terminal, the method can further include that the second terminal sends the first SL RRC reconfiguration message to the second network device.

After the second terminal has received the sixth SL RRC reconfiguration message from the third terminal, the method can further include that the second terminal sends the sixth SL RRC reconfiguration message to the second network device.

After the second terminal has received the third SL RRC reconfiguration message from the third terminal, the method can further include that the second terminal sends the third SL RRC reconfiguration message to the second network device.

After the second terminal has received the fourth SL RRC reconfiguration message from the first terminal, the method can further include that the second terminal sends the fourth SL RRC reconfiguration message to the second network device.

When the second terminal has received at least one of: the first SL RRC reconfiguration message, the third SL RRC reconfiguration message, the fourth SL RRC reconfiguration message, or the sixth SL RRC reconfiguration message, the second terminal can choose to send only any one of them to the second network device, or can choose to send all of them, all of which are within the scope of protection of this embodiment, which are not repeated herein.

The description of the second network device is the same as that of the foregoing embodiments, which is not repeated herein. Correspondingly, when the second network device has received at least one of: the first SL RRC reconfiguration message, the sixth SL RRC reconfiguration message, the third SL RRC reconfiguration message, or the fourth SL RRC reconfiguration message, the method can further include that the second network device sends to the second terminal an updated SL RRC reconfiguration message corresponding to the second terminal. The updated SL RRC reconfiguration message corresponding to the second terminal can be sent to the second terminal when the second network device determines that changes occur in at least one of: the resource pool related configuration of the second terminal, the SL discontinuous reception related configuration of the second terminal, the SL bearer configuration of the second terminal, or the terminal capability information indication of the second terminal.

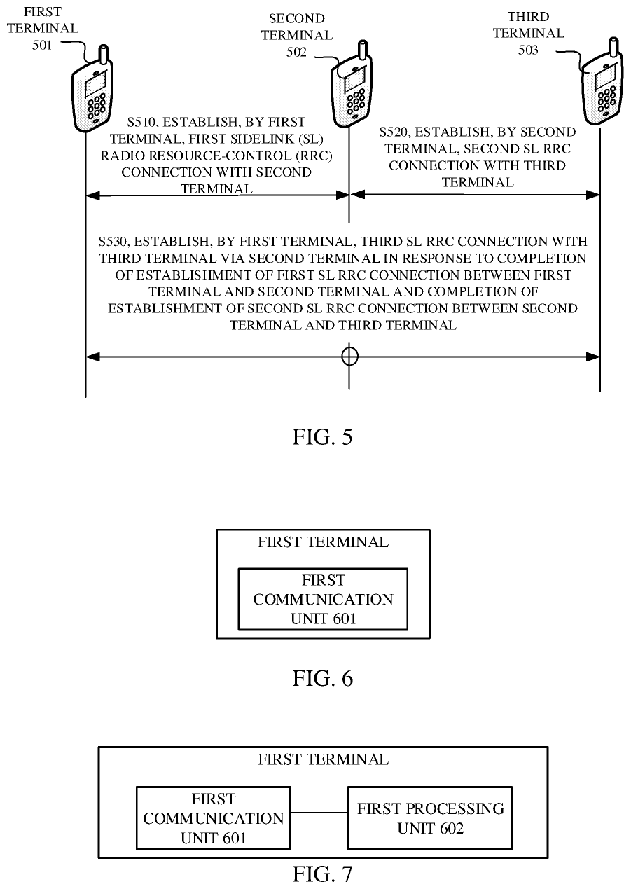

The method 300 for connection establishment and the method 400 for connection establishment provided in the present disclosure are applicable to a system as illustrated in FIG. 5. The system includes a first terminal 501, a second terminal 502, and a third terminal 503. The second terminal 502 can be a relay terminal. The first terminal 501 can be a source remote terminal, and the third terminal 503 can be a target remote terminal. Alternatively, the first terminal 501 can be a target remote terminal, and the third terminal 503 can be a source remote terminal. As illustrated in FIG. 5, the processing of the first terminal 501, the second terminal 502, and the third terminal 503 is illustrated exemplarily.

S510, a first terminal establishes a first SL RRC connection with a second terminal.

S520, the second terminal establishes a second SL RRC connection with a third terminal.

The execution order of S510 and S520 can be in no particular order.

S530, when the establishment of the first SL RRC connection between the first terminal and the second terminal is completed and the establishment of the second SL RRC connection between the second terminal and the third terminal is completed, the first terminal establishes a third SL RRC connection with the third terminal via the second terminal.

It can be understood that the above is only an exemplary illustration, and for the specific processing manner of establishing the first SL RRC connection between the first terminal and the second terminal and determining that the establishment of the first SL RRC connection is completed, the specific processing manner of establishing the second SL RRC connection between the second terminal and the third terminal and determining that the establishment of the second SL RRC connection is completed, the specific processing manner of the first terminal establishing the third SL RRC connection with the third terminal via the second terminal, the execution order of establishing the first SL RRC connection and establishing the second SL RRC connection, etc., reference can be made to the foregoing embodiments, which are not repeated herein.

Finally, the solutions provided in the present disclosure are analyzed in combination with related technologies. The D2D communication is an SL transmission technology. Unlike the manner adopted in the conventional cellular system in which communication data is received or sent by the base station, terminal-to-terminal direct communication is adopted in the D2D communication system. In this way, whether two SL terminals are able to normally send data to each other or communicate with each other can be limited by the communication range or the communication distance of the two SL terminals, and thus how to expand the communication range of the two SL terminals becomes a problem to be solved. In related technologies, a solution that a terminal communicates with a network via a relay is provided, which can expand the communication range or the communication distance of the terminal to a certain extent. However, in such a solution, an SL is used only between the terminal and the relay terminal, and such a solution requires that at least one of the terminal or the relay terminal is within the coverage of the cell, while in the D2D scenario, the two SL terminals that need to communicate with each other can have some or all of their terminals outside the coverage of the cell, so it can be seen that this solution is not applicable to the D2D scenario. Based on this, a terminal-to-terminal relay connection manner is provided in the method for connection establishment in the present disclosure. With the method provided in the present disclosure, when the second terminal completes the establishment of the SL RRC connection with the first terminal and the establishment of the SL RRC connection with the third terminal, respectively, the first terminal can establish the third SL RRC connection with the third terminal via the second terminal. In this way, in the solution of the present disclosure, the establishment of the SL RRC connection between the first terminal and the third terminal can be established via the second terminal, so that the SL communication range between the first terminal and the third terminal is effectively expanded through the relay transmission of the second terminal in the D2D scenario, thereby improving the coverage of the SL communication. In the related technologies, the SL is used only between the terminal and the relay terminal in the solution that the terminal communicates with the network via the relay, while the solution of the present disclosure is applicable to the D2D scenario and can realize that in the D2D scenario, the SL communication range between the first terminal and the third terminal is effectively expanded through the relay transmission of the second terminal, thereby improving the coverage of the SL communication.

FIG. 6 is a schematic block diagram of a first terminal according to an embodiment of the present disclosure. The first terminal can include a first communication unit 601. The first communication unit 601 is configured to establish a third SL RRC connection with a third terminal via a second terminal when establishment of a first SL RRC connection with the second terminal is completed and establishment of a second SL RRC connection between the second terminal and the third terminal is completed.

The first communication unit 601 is configured to establish the first SL RRC connection with the second terminal.

As illustrated in FIG. 7, in addition to the first communication unit 601, the first terminal further includes a first processing unit 602. The first processing unit 602 is configured to complete the establishment of the first SL RRC connection with the second terminal when the first communication unit has received a first SL RRC reconfiguration complete message from the second terminal. The first communication unit 601 is configured to send a first SL RRC reconfiguration message to the second terminal.

The first processing unit 602 is configured to start a first timer when the first communication unit sends the first SL RRC reconfiguration message to the second terminal.

The first processing unit is configured to stop the first timer when the first communication unit has received the first SL RRC reconfiguration complete message from the second terminal, and complete the establishment of the first SL RRC connection with the second terminal.

The first communication unit 601 is configured to send first indication information to the second terminal when the first communication unit has received the first SL RRC reconfiguration complete message from the second terminal, where the first indication information is used to confirm the completion of the establishment of the first SL RRC connection.

The first processing unit 602 is configured to determine that the first SL RRC connection reconfiguration fails when the first processing unit 602 meets a first condition, where the first condition includes one of: the first timer expires; the first communication unit has received a first SL RRC reconfiguration failure message from the second terminal before the first timer expires; the first communication unit has received second indication information from the second terminal, where the second indication information indicates that the first timer is to be stopped; and determining to stop the establishment of the first SL RRC connection before the first timer expires.

The first processing unit 602 is configured to complete the establishment of the first SL RRC connection with the second terminal when the first communication unit sends a second SL RRC reconfiguration complete message to the second terminal. The first processing unit 602 is configured to receive a second SL RRC reconfiguration message from the second terminal and to send the second SL RRC reconfiguration complete message to the second terminal.

The first processing unit 602 is configured to start a second timer when the first communication unit sends the second SL RRC reconfiguration complete message to the second terminal.

The first communication unit is configured to receive third indication information from the second terminal. The first processing unit is configured to stop the second timer and to determine that the establishment of the first SL RRC connection with the second terminal is completed, where the third indication information is used to confirm the completion of the establishment of the first SL RRC connection.

The first communication unit is configured to receive a first message from the second terminal, where the first message is related to a third SL RRC reconfiguration message sent to the second terminal from the third terminal. The first processing unit is configured to stop the second timer, determine that the establishment of the first SL RRC connection with the second terminal is completed, and determine that the establishment of the second SL RRC connection between the second terminal and the third terminal is completed.

The first processing unit is configured to control the first communication unit to release the first SL RRC connection with the second terminal when the second timer expires.

The first communication unit is configured to receive fourth indication information from the second terminal, where the fourth indication information indicates whether the establishment of the second SL RRC connection between the second terminal and the third terminal is completed.

The first processing unit is configured to control the first communication unit to release the first SL RRC connection with the second terminal when the fourth indication information indicates that establishment of the second SL RRC connection between the second terminal and the third terminal fails.

The first processing unit is configured to determine that the establishment of the second SL RRC connection between the second terminal and the third terminal is completed when the fourth indication information indicates that the establishment of the second SL RRC connection between the second terminal and the third terminal is completed.

The first communication unit is configured to receive a first message from the second terminal and send a third SL RRC reconfiguration complete message to the third terminal via the second terminal. The first processing unit is configured to determine that the establishment of the third SL RRC connection with the third terminal is completed via the second terminal when the first communication unit sends the third SL RRC reconfiguration complete message to the third terminal via the second terminal.

The first communication unit is configured to receive a first message from the second terminal. The first processing unit is configured to determine that the establishment of the second SL RRC connection between the second terminal and the third terminal is completed when the first communication unit has received the first message, where the first message is related to a third SL RRC reconfiguration message sent to the second terminal from the third terminal.

The first communication unit is configured to send a third SL RRC reconfiguration complete message to the third terminal via the second terminal when the first communication unit has received the first message from the second terminal. The first processing unit is configured to determine that the third SL RRC connection between the first terminal and the third terminal is established when the first communication unit sends the third SL RRC reconfiguration complete message to the third terminal via the second terminal.

The first message includes one of: a third SL RRC reconfiguration message; and a part of information in the third SL RRC reconfiguration message.

The first communication unit is configured to send a fourth SL RRC reconfiguration message to the second terminal, where the fourth SL RRC reconfiguration message is used by the second terminal to determine a second message, and the second message is to be sent by the second terminal to the third terminal. The first processing unit is configured to determine that the establishment of the third SL RRC connection with the third terminal is completed via the second terminal in response to the first communication unit having received a fourth SL RRC reconfiguration complete message from the third terminal via the second terminal.

The second message includes one of: the fourth SL RRC reconfiguration message; and a part of information in the fourth SL RRC reconfiguration message.

The first processing unit is configured to start a third timer when the first communication unit sends the fourth SL RRC reconfiguration message to the second terminal.

The first processing unit is configured to stop the third timer when the first communication unit has received the fourth SL RRC reconfiguration complete message from the third terminal via the second terminal, and determine that the establishment of the third SL RRC connection with the third terminal is completed via the second terminal.

The first processing unit is configured to determine that the third SL RRC connection reconfiguration fails in response to the first processing unit meets a second condition, where the second condition includes one of: the third timer expires; the first communication unit has received a fourth SL RRC reconfiguration failure message from the third terminal before the third timer expires; the first communication unit has received fifth indication information from the third terminal, where the fifth indication information indicates that the third timer is to be stopped; and determining to stop the establishment of the third SL RRC connection before the third timer expires.

The first communication unit is configured to send the second SL RRC reconfiguration message to a first network device.

The first communication unit is configured to send the first message to the first network device.

The SL RRC reconfiguration message includes at least one of: a resource pool related configuration, an SL discontinuous reception related configuration, an SL bearer configuration, or a terminal capability information indication.

The first terminal is a source remote terminal, and the third terminal is a target remote terminal.

The first terminal is a target remote terminal, and the third terminal is a source remote terminal.

The second terminal is a relay terminal.

The first terminal in embodiments of the disclosure can implement corresponding functions of the terminal device in the foregoing method embodiments. For the procedure, function, implementation, and advantage corresponding to each module (sub-module, unit, or assembly, etc.) in the first terminal, reference can be made to the corresponding illustrations in the foregoing method embodiments, which will not be described in detail again herein. It can be noted that, the functions of various modules (sub-modules, units, or assemblies, etc.) in the first terminal described in embodiments of the disclosure may be implemented by different modules (sub-modules, units, or assemblies, etc.), or may be implemented by the same module (sub-module, unit, or assembly, etc.).

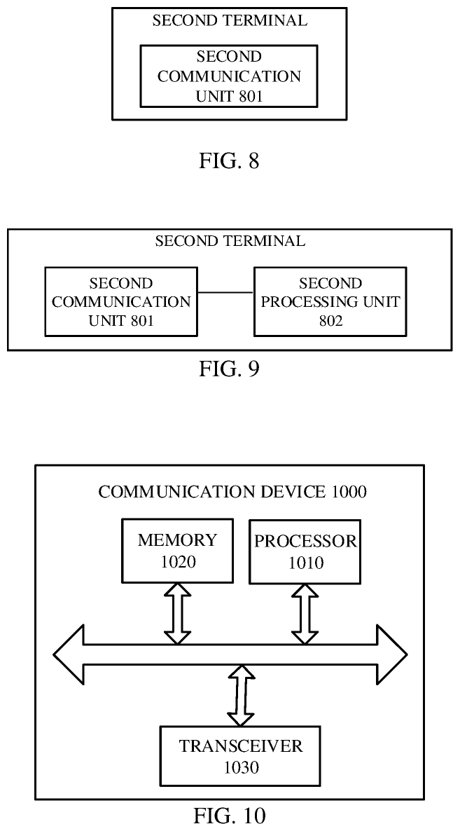

FIG. 8 is a schematic block diagram of a second terminal according to an embodiment of the present disclosure. The second terminal can include a second communication unit 801. The second communication unit 801 is configured to establish a first SL RRC connection with a first terminal and establish a second SL RRC connection with a third terminal. On the basis of FIG. 8, as illustrated in FIG. 9, the second terminal further includes a second processing unit 802. The second processing unit 802 is configured to determine that the establishment of the first SL RRC connection with the first terminal is completed when the second communication unit sends a first SL RRC reconfiguration complete message to the first terminal. The second communication unit 801 is configured to send the first SL RRC reconfiguration complete message to the first terminal in response to the second communication unit having received a first SL RRC reconfiguration message from the first terminal.

The second processing unit 802 is configured to start a fourth timer when the second communication unit sends the first SL RRC reconfiguration complete message to the first terminal.

The second processing unit 802 is configured to control the second communication unit to release the first SL RRC connection when the fourth timer expires.

The second processing unit 802 is configured to determine that the establishment of the first SL RRC connection with the first terminal is completed when the second communication unit has received first indication information from the first terminal, where the first indication information is used to confirm the completion of the establishment of the first SL RRC connection.

The second processing unit 802 is configured to stop the fourth timer when the second communication unit has received the first indication information from the first terminal.

The second communication unit 801 is configured to send a fifth SL RRC reconfiguration message to the third terminal and receive a fifth SL RRC reconfiguration complete message from the third terminal. The second processing unit is configured to stop the fourth timer when the second communication unit sends the fifth SL RRC reconfiguration message to the third terminal, and determine that the establishment of the second SL RRC connection with the third terminal is completed when the second communication unit has received the fifth SL RRC reconfiguration complete message from the third terminal.

The second processing unit is configured to determine that the establishment of the first SL RRC connection with the first terminal is completed when the second communication unit has received a second SL RRC reconfiguration complete message from the first terminal. The second communication unit is configured to send a second SL RRC reconfiguration message to the first terminal and receive the second SL RRC reconfiguration complete message from the first terminal.

The second processing unit is configured to start a fifth timer when the second communication unit sends the second SL RRC reconfiguration message to the first terminal.

The second processing unit is configured to stop the fifth timer when the second communication unit has received the second SL RRC reconfiguration complete message from the first terminal, and determine that the establishment of the first SL RRC connection with the first terminal is completed.

The second communication unit is configured to send third indication information to the first terminal when the second communication unit has received the second SL RRC reconfiguration complete message from the first terminal, where the third indication information is used to confirm the completion of the establishment of the first SL RRC connection.

The second processing unit is configured to determine that the first SL RRC connection reconfiguration fails when the second processing unit meets a third condition, where the third condition includes one of: the fifth timer expires; the second communication unit has received a second SL RRC reconfiguration failure message from the first terminal before the fifth timer expires; the second communication unit has received sixth indication information from the first terminal, where the sixth indication information indicates that the fifth timer is to be stopped; and determining to stop the establishment of the first SL RRC connection before the fifth timer expires.

The second communication unit is configured to send seventh indication information to the third terminal when the second SL RRC connection with the third terminal is established, where the seventh indication information indicates whether the establishment of the first SL RRC connection is completed.

The second processing unit is configured to determine that the establishment of the second SL RRC connection with the third terminal is completed when the second communication unit has received a fifth SL RRC reconfiguration complete message from the third terminal. The second communication unit is configured to send a fifth SL RRC reconfiguration message to the third terminal.

The second processing unit is configured to start a sixth timer when the second communication unit sends the fifth SL RRC reconfiguration message to the third terminal.

The second processing unit is configured to stop the sixth timer when the second communication unit has received the fifth SL RRC reconfiguration complete message from the third terminal, and determine that the second SL RRC connection with the third terminal is established.

The second communication unit is configured to send seventh indication information to the third terminal when the second communication unit has received the fifth SL RRC reconfiguration complete message from the third terminal, where the seventh indication information is used to confirm the completion of the establishment of the second SL RRC connection.

The second processing unit is configured to determine that the second SL RRC connection reconfiguration fails in response to the second processing unit meets a fourth condition, where the fourth condition includes one of: the sixth timer expires; the second communication unit has received a fifth SL RRC reconfiguration failure message from the third terminal before the sixth timer expires; the second communication unit has received eighth indication information from the third terminal, where the eighth indication information indicates that the sixth timer is to be stopped; and determining to stop the establishment of the second SL RRC connection before the sixth timer expires.

The second processing unit is configured to complete the establishment of the second SL RRC connection with the third terminal when the second communication unit sends a sixth SL RRC reconfiguration complete message to the third terminal. The second communication unit is configured to send a sixth SL RRC reconfiguration complete message to the third terminal when the second communication unit has received the sixth SL RRC reconfiguration message from the third terminal.

The second processing unit is configured to start a seventh timer when the second communication unit sends the sixth SL RRC reconfiguration complete message to the third terminal.

The second processing unit is configured to control the second communication unit to release the second SL RRC connection when the seventh timer expires.

The second processing unit is configured to determine that the establishment of the second SL RRC connection with the third terminal is completed when the second communication unit has received ninth indication information from the third terminal, where the ninth indication information is used to confirm the completion of the establishment of the second SL RRC connection.

The second processing unit is configured to stop the seventh timer when the second communication unit has received the ninth indication information from the third terminal.

The second processing unit is configured to stop the seventh timer when the second communication unit sends the second SL RRC reconfiguration message to the first terminal.

The second processing unit is configured to control the second communication unit to send fourth indication information to the first terminal when the first SL RRC connection between the second terminal and the first terminal is established, where the fourth indication information indicates whether the establishment of the second SL RRC connection between the second terminal and the third terminal is completed. The second communication unit is configured to send the fourth indication information to the first terminal.

The second communication unit is configured to receive a third SL RRC reconfiguration message from the third terminal when the establishment of the first SL RRC connection between the second terminal and the first terminal is completed and the establishment of the second SL RRC connection between the second terminal and the third terminal is completed, send a first message to the first terminal, where the first message is related to the third SL RRC reconfiguration message, and forward a third SL RRC reconfiguration complete message sent to the third terminal from the first terminal.

The first message includes one of: the third SL RRC reconfiguration message; and a part of information in the third SL RRC reconfiguration message.

The second communication unit is configured to receive a fourth SL RRC reconfiguration message from the first terminal when the establishment of the first SL RRC connection between the second terminal and the first terminal is completed and the establishment of the second SL RRC connection between the second terminal and the third terminal is completed, send a second message to the third terminal, where the second message is related to the fourth SL RRC reconfiguration message, and forward a fourth SL RRC reconfiguration complete message sent to the first terminal from the third terminal.

The second message includes one of: the fourth SL RRC reconfiguration message; and a part of information in the fourth SL RRC reconfiguration message.

The second communication unit is configured to send the first SL RRC reconfiguration message to a second network device.

The second communication unit is configured to send the sixth SL RRC reconfiguration message to the second network device.

The second communication unit is configured to send the third SL RRC reconfiguration message to the second network device.

The second communication unit is configured to send the fourth SL RRC reconfiguration message to the second network device.

The SL RRC reconfiguration message includes at least one of: a resource pool related configuration, an SL discontinuous reception related configuration, an SL bearer configuration, or a terminal capability information indication.

The first terminal is a source remote terminal, and the third terminal is a target remote terminal.

The first terminal is a target remote terminal, and the third terminal is a source remote terminal.

The second terminal is a relay terminal.

The second terminal in embodiments of the disclosure can implement corresponding functions of the terminal device in the foregoing method embodiments. For the procedure, function, implementation, and advantage corresponding to each module (sub-module, unit, or assembly, etc.) in the second terminal, reference can be made to the corresponding illustrations in the foregoing method embodiments, which will not be described in detail again herein. It can be noted that, the functions of various modules (sub-modules, units, or assemblies, etc.) in the second terminal described in embodiments of the disclosure may be implemented by different modules (sub-modules, units, or assemblies, etc.), or may be implemented by the same module (sub-module, unit, or assembly, etc.).

FIG. 10 is a schematic structural diagram of a communication device 1000 according to embodiments of the present disclosure. The communication device 1000 includes a processor 1010. The processor 1010 can invoke and execute a computer program stored in a memory, to cause the communication device 1000 to implement the method in embodiments of the disclosure.

In an embodiment, the communication device 1000 can further include a memory 1020. The processor 1010 can invoke and execute a computer program stored in the memory 1020, to cause the communication device 1000 to implement the method in embodiments of the disclosure. The memory 1020 can be a separate device independent of the processor 1010, or can be integrated into the processor 1010. In an embodiment, the communication device 1000 may further include a transceiver 630. The processor 1010 can control the transceiver 1030 to communicate with other devices, and specifically, to send information or data to other devices or receive information or data sent by other devices. The transceiver 1030 may include a sender and a receiver. The transceiver 1030 can further include an antenna, where one or more antennas may be provided. In an embodiment, the communication device 1000 can be the first terminal in embodiments of the present disclosure, and the communication device 1000 can implement corresponding operations implemented by the first terminal in various methods in embodiments of the disclosure, which is not repeated herein for the sake of brevity. In an embodiment, the communication device 1000 can be the second terminal in embodiments of the present disclosure, and the communication device 1000 can implement corresponding operations implemented by the second terminal in various methods in embodiments of the disclosure, which is not repeated herein for the sake of brevity.

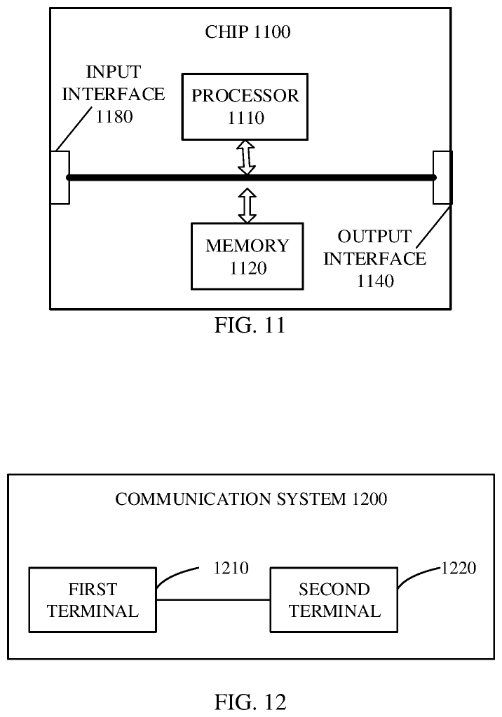

FIG. 11 is a schematic structural diagram of a chip 1100 according to embodiments of the present disclosure. The chip 1100 includes a processor 1110. The processor 1110 can invoke and execute a computer program stored in a memory, to implement the method in embodiments of the present disclosure. In an embodiment, the chip 1100 can further include a memory 1120. The processor 1110 can invoke and execute a computer program stored in the memory 1120, to implement the method implemented by the terminal device or the network device in embodiments of the present disclosure. The memory 1120 can be a separate device independent of the processor 1110, or can be integrated into the processor 1110. In an embodiment, the chip 1100 can further include an input interface 1130. The processor 1110 can control the input interface 1130 to communicate with other devices or chips, and specifically, to obtain information or data sent by other devices or chips. In an embodiment, the chip 1100 can further include an output interface 1140. The processor 1110 can control the output interface 1140 to communicate with other devices or chips, and specifically, to output information or data to other devices or chips. In an embodiment, the chip can be applied to the first terminal in embodiments of the disclosure, and the chip can implement corresponding operations implemented by the first terminal in various methods in embodiments of the disclosure, which is not repeated herein for the sake of brevity. In an embodiment, the chip can be applied to the second terminal in embodiments of the disclosure, and the chip can implement corresponding operations implemented by the second terminal in various methods in embodiments of the disclosure, which is not repeated herein for the sake of brevity. The chip applied to the first terminal can be the same as or different from the chip applied to the second terminal.

It can be understood that the chip mentioned in embodiments of the present disclosure can also be referred to as a system-on-chip (SOC). The processor can be a general-purpose processor, a digital signal processor (DSP), an application-specific integrated circuit (ASIC), a field programmable gate array (FPGA), or other programmable logic devices, discrete gates or transistor logic devices, discrete hardware components. The general-purpose processor can be a microprocessor, any conventional processor, etc. The memory can be a volatile memory or a non-volatile memory, or can include both the volatile memory and the non-volatile memory. The non-volatile memory can be a read-only memory (ROM), a programmable ROM (PROM), an erasable PROM (EPROM), an electrically EPROM (EEPROM), or a flash memory. The volatile memory can be a random access memory (RAM). It can be understood that the memory above is intended for illustration rather than limitation. For example, the memory in embodiments of the present disclosure can also be a static RAM (SRAM), a dynamic RAM (DRAM), a synchronous DRAM (SDRAM), a double data rate SDRAM (DDR SDRAM), an enhanced SDRAM (ESDRAM), a synchlink DRAM (SLDRAM), a direct rambus RAM (DR RAM), etc. In other words, the memory in embodiments of the present disclosure is intended to include, but is not limited to, these and any other suitable types of memory.

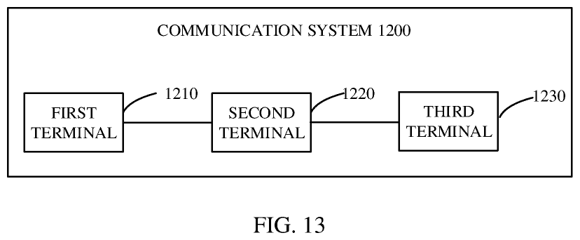

FIG. 12 is a schematic block diagram of a communication system 1200 according to embodiments of the present disclosure. The communication system 1200 includes a first terminal 1210 and a second terminal 1220. The first terminal 1210 is configured to perform the method for connection establishment, and the second terminal 1220 is configured to perform the method for connection establishment. The first terminal 1210 can be configured to implement corresponding functions implemented by the first terminal in the method mentioned above, and the second terminal 1220 can be configured to implement corresponding functions implemented by the second terminal in the method mentioned above, which are not repeated herein for the sake of brevity. Further, on the basis of FIG. 12, as illustrated in FIG. 13, the communication system 1200 in embodiments of the present disclosure can further include a third terminal 1230. The third terminal 1230 can establish an SL RRC connection with the first terminal 1210 via the second terminal 1220, and the third terminal 1230 can be configured to implement corresponding functions implemented by the third terminal in the method mentioned above, which is not repeated herein.

All or some of the above embodiments can be implemented through software, hardware, firmware, or any other combination thereof. When implemented by software, all or some of the above embodiments can be implemented in the form of a computer program product. The computer program product includes one or more computer instructions. When the computer instructions are applied and executed on a computer, all or some of the operations or functions of the embodiments of the present disclosure are performed. The computer can be a general-purpose computer, a special-purpose computer, a computer network, or other programmable apparatuses. The computer instruction can be stored in a non-transitory computer-readable storage medium, or sent from one computer-readable storage medium to another computer-readable storage medium. For example, the computer instruction can be sent from one website, computer, server, or data center to another website, computer, server, or data center in a wired manner or in a wireless manner. Examples of the wired manner can be a coaxial cable, an optical fiber, a digital subscriber line (DSL), etc. The wireless manner can be, for example, infrared, wireless, microwave, etc. The computer-readable storage medium can be any computer-accessible usable medium or a data storage device such as a server, a data center, or the like which integrates one or more usable media. The usable medium can be a magnetic medium (such as a soft disk, a hard disk, or a magnetic tape), an optical medium (such as a digital video disc (DVD)), or a semiconductor medium (such as a solid state disk (SSD)), etc.

It can be understood that, in various embodiments of the present disclosure, the magnitude of a sequence number of each process does not mean an order of execution, and the order of execution of each process can be determined by its function and internal logic and shall not constitute any limitation to the embodiment of the embodiments of the present disclosure.

It will be evident to those skilled in the art that, for the sake of convenience and simplicity, in terms of the specific working processes of the foregoing systems, apparatuses, and units, reference can be made to the corresponding processes in the foregoing method embodiments, which is not repeated herein.

The foregoing elaborations are merely embodiments of the present disclosure, but are not intended to limit the protection scope of the present disclosure. Any variation or replacement easily thought of by those skilled in the art within the technical scope disclosed in the present disclosure shall belong to the protection scope of the present disclosure. Therefore, the protection scope of the present disclosure shall be subject to the protection scope of the claims.

What is claimed is:

1. A method for connection establishment, comprising:
establishing, by a first terminal, a third sidelink (SL) radio resource-control (RRC) connection with a third terminal via a second terminal in response to completion of establishment of a first SL RRC connection between the first terminal and the second terminal and completion of establishment of a second SL RRC connection between the second terminal and the third terminal.

2. The method of claim 1, further comprising:
establishing, by the first terminal, the first SL RRC connection with the second terminal.

3. The method of claim 2, wherein establishing, by the first terminal, the first SL RRC connection with the second terminal comprises:
sending, by the first terminal, a first SL RRC reconfiguration message to the second terminal; and
completing, by the first terminal, the establishment of the first SL RRC connection with the second terminal in response to reception of a first SL RRC reconfiguration complete message by the first terminal from the second terminal.

4. The method of claim 1, further comprising:
receiving, by the first terminal, fourth indication information from the second terminal, wherein the fourth indication information indicates whether the establishment of the second SL RRC connection between the second terminal and the third terminal is completed.

5. The method of claim 4, further comprising:
releasing, by the first terminal, the first SL RRC connection with the second terminal in response to the fourth indication information indicating that establishment of the second SL RRC connection between the second terminal and the third terminal fails.

6. The method of claim 4, further comprising:
determining, by the first terminal, that the establishment of the second SL RRC connection between the second terminal and the third terminal is completed in response to the fourth indication information indicating that the establishment of the second SL RRC connection between the second terminal and the third terminal is completed.

7. The method of claim 6, wherein establishing, by the first terminal, the third SL RRC connection with the third terminal via the second terminal comprises:
receiving, by the first terminal, a first message from the second terminal; and
sending, by the first terminal, a third SL RRC reconfiguration complete message to the third terminal via the second terminal, and completing, by the first terminal, the establishment of the third SL RRC connection with the third terminal via the second terminal.

8. The method of claim 3, wherein the SL RRC reconfiguration message comprises at least one of:
a resource pool related configuration, an SL discontinuous reception related configuration, an SL bearer configuration, or a terminal capability information indication.

9. The method of claim 1, wherein the first terminal is a source remote terminal, and the third terminal is a target remote terminal.

10. The method of claim 1, wherein the second terminal is a relay terminal.

11. A method for connection establishment, comprising:
establishing, by a second terminal, a first sidelink (SL) radio resource-control (RRC) connection with a first terminal; and
establishing, by the second terminal, a second SL RRC connection with a third terminal.

12. The method of claim 11, wherein establishing, by the second terminal, the first SL RRC connection with the first terminal comprises:
sending, by the second terminal, a first SL RRC reconfiguration complete message to the first terminal in response to reception of a first SL RRC reconfiguration message by the second terminal from the first terminal, and completing, by the second terminal, the establishment of the first SL RRC connection with the first terminal.

13. The method of claim 11, wherein establishing, by the second terminal, the second SL RRC connection with the third terminal comprises:
sending, by the second terminal, a fifth SL RRC reconfiguration message to the third terminal; and
completing, by the second terminal, the establishment of the second SL RRC connection with the third terminal in response to reception of a fifth SL RRC reconfiguration complete message by the second terminal from the third terminal.

14. The method of claim 13, further comprising:
sending, by the second terminal, fourth indication information to the first terminal in response to establishment of the first SL RRC connection between the second terminal and the first terminal, wherein the fourth indication information indicates whether the establishment of the second SL RRC connection between the second terminal the third terminal is completed.

15. The method of claim 11, further comprising:
receiving, by the second terminal, a third SL RRC reconfiguration message from the third terminal in response to completion of the establishment of the first SL RRC connection between the second terminal and the first terminal and completion of the establishment of the second SL RRC connection between the second terminal and the third terminal;
sending, by the second terminal, a first message to the first terminal, wherein the first message is related to the third SL RRC reconfiguration message; and
forwarding, by the second terminal, a third SL RRC reconfiguration complete message sent to the third terminal from the first terminal.

16. The method of claim 12, wherein the SL RRC reconfiguration message comprises at least one of:
a resource pool related configuration, an SL discontinuous reception related configuration, an SL bearer configuration, or a terminal capability information indication.

17. The method of claim 11, wherein the first terminal is a source remote terminal, and the third terminal is a target remote terminal.

18. The method of claim 11, wherein the second terminal is a relay terminal.

19. A first terminal, comprising:
a processor; and
a memory configured to store a computer program, which when executed by the processor, causes the first terminal to:
establish a third sidelink (SL) radio resource-control (RRC) connection with a third terminal via a second terminal in response to completion of establishment of a first SL RRC connection between the first terminal and the second terminal and completion of establishment of a second SL RRC connection between the second terminal and the third terminal.

20. The first terminal of claim 19, wherein the computer program, which when executed by the processor, further causes the first terminal to:
establish the first SL RRC connection with the second terminal.
